(19) United States
(12) Patent Application Publication
(10) Pub. No.: US 2026/0365574 A1
(43) Pub. Date: Nov. 19, 2026

(54) SYSTEM AND METHOD FOR COMPOSITE CARBON ABSORBING BUILDING MATERIAL

(71) Applicant: SUPERNATURAL HOLDINGS, PBC, Benicia, CA (US)

(72) Inventors: Alicia R. Garcia-Romero, Benicia, CA (US); Tom Vermeeren, Quathiaski Cove (CA)

(21) Appl. No.: 19/722,005

(22) Filed: Jun. 26, 2026

Related U.S. Application Data
(63) Continuation of application No. PCT/US2024/062063, filed on Dec. 27, 2024.
(60) Provisional application No. 63/615,554, filed on Dec. 28, 2023.

(51) Int. Cl. C04B 22/06; C04B 14/22; C04B 18/14; C04B 22/14; C04B 24/16; C04B 24/38; C04B 103/00; C04B 103/67; C04B 111/00; C04B 111/72

(52) U.S. Cl. CPC C04B 22/06; C04B 14/22; C04B 18/146; C04B 22/143; C04B 24/168; C04B 24/386; C04B 2103/0079; C04B 2103/67; C04B 2111/00017; C04B 2111/72

(57) ABSTRACT

The present disclosure provides methods and compositions of building materials for carbon sequestration. The compositions include magnesium oxide or magnesium hydroxide, a lime material comprising a calcium oxide and/or a calcium hydroxide; and a pozzolan comprising at least one material selected from the group consisting of ash (e.g., rice husk, coconut, ceramic), fly ash, vitrified calcium aluminio-silicate, blast furnace slag, ground granulated blast-furnace slag (GGBFS), zeolites, diatomaceous earth, silica fume, amorphous aluminosilicate, glass phase pozzolan, fume silica, metakaolin, calcinated diatomaceous earth, biochar, geopolymers, kaolinitic clays, volcanic ash, silica fume, pozzolanic lime, precipitated silica, carbon nanotubes, calcinated silicate pozzolan, synthetic pozzolan, pozzolan powders (e.g., glass, brick). The disclosure also provides methods for absorbing carbon dioxide using the disclosed building material.

### CROSS-REFERENCE

The present application is continuation of International Patent Application No. PCT/US2024/062063, filed on Dec. 27, 2024, which claims the benefit of U.S. Provisional Application No. 63/615,554, filed on Dec. 28, 2023, each of which is entirely incorporated herein by reference in its entirety.

### BACKGROUND

Construction has historically been a high-impact industry for emissions and waste. Many building materials are energy intensive to make, and transportation of these materials across the globe adds to their carbon footprint before construction ever begins. There have been many global and national initiatives to improve the energy efficiency of buildings, such as Leadership in Energy and Environmental Design (LEED) in the United States. Many such initiatives specifically recognize the carbon footprint and life cycle of the building materials used. Advances in such green building materials, particularly joint compound, has lagged behind such initiatives. As governments strive to meet global and national carbon goals, there is a significant need for improvement in the carbon footprint of these building materials.

In addition to environmental considerations, the construction industry must also address concerns for the health of its workers. Inhalation of crystalline silica, a byproduct in existing joint compounds, has been linked to a higher risk of silicosis, lung cancer, chronic obstructive pulmonary disease (COPD), and kidney disease. This has been recognized by numerous organizations; Notably, the American Journal of Respiratory and Critical Care specifically highlight a high prevalence of silicosis among drywall installers. As we strive to improve the carbon footprint of building materials to reduce the negative environmental impact, so too should focus be given to reduce the negative human impact of building materials.

### SUMMARY

In one aspect, the present application provides methods and systems for the absorption of greenhouse gasses by building materials. Specifically, the composition of the building materials comprises one or more active ingredients for the absorption of greenhouse gasses. This provides a method and building material composition for sequestering greenhouse gasses, wherein said building material composition described herein comprising said active ingredients is exposed to an environment comprising carbon dioxide and thereby sequesters at least a portion of said carbon dioxide. The composition of the building materials further comprises recycled, low carbon, carbon neutral, or compostable ingredients, reducing the manufacturing carbon footprint compared to other common building materials not comprising recycled, low carbon, carbon neutral, or compostable material. The composition of the building materials further comprises recyclable or compostable ingredients such that the building material composition is recyclable at end of its life, reducing waste by eliminating the need for disposal in a landfill. The composition of the building materials further comprises soil enhancing minerals such that the building material composition may be utilized as a soil enhancement at the end of its life. Additionally, by controlling the concentration of hazardous materials commonly found in building materials, the composition of the building materials improves the safety of working conditions where they are used.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the figures and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### CERTAIN DEFINITIONS AND ADDITIONAL CONSIDERATIONS

Unless otherwise defined, all technical terms used herein have the same meaning as commonly understood by one of ordinary skill in the art to which this invention belongs. As used herein, the singular forms “a,” “an,” and “the” include plural references unless the context clearly dictates otherwise. Any reference to “or” herein is intended to encompass “and/or” unless otherwise stated.

As used herein, the phrase “at least one of A and B” has the same meaning as “A, B, or A and B.”

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

When a range of values is provided, it is to be understood that each intervening value between the upper and lower limit of that range, and any other stated or intervening value in that stated range is encompassed within the scope of the present disclosure. Where the stated range includes upper or lower limits, ranges excluding either of those included limits are also included in the present disclosure. When ranges are used herein for physical properties, such as molecular weight, or chemical properties, such as chemical formulas, all combinations and subcombinations of ranges and specific embodiments therein are intended to be included. values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” generally refers to include not just about 0.1% to about 5%, but also the individual values (e.g., 0.5%, 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

As used herein, the term “about” or “nearly” when referring to a number or a numerical range means that the number or numerical range generally referred to is within +/−15%, 10%, 9%, 8%, 7%, 6%, 5%, 4%, 3%, 2%, or 1% of the stated number or numerical range.

As used herein, the term “substantially” generally refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

As used herein, the term “substantially pure” means the compound or salt has a purity of about 95% or more (i.e., contains less than about 5% of other organic/inorganic components). In some embodiments, the compound or salt has a purity of about 99% or more (i.e., contains less than about 1% of other such components). In some embodiments, the compound or salt has a purity of about 99.5% or more (i.e., contains less than about 0.5% of other such components).

Where compositions are described in percentages, the percentage refers to percent by weight unless expressly stated otherwise.

### Carbon-Absorbing Construction Materials

This disclosure relates to building materials (or construction materials), and more particularly to a carbon-absorbing, benign material that is suitable for construction and décor that reduces the carbon footprint made by the building industry, protects the health of installers, fabricators, building occupants, and reduces waste. This disclosure has broad applications in the construction industry as a joint compound, wallboard, acoustical tile, tile, as a structural material or decorative material, particularly in 3D construction, cement, as well as decor, furniture, large scale art, and other areas where a building material is needed. Variations of the materials in each category are included to applications and installation methods.

There is limited focus on sustainability in construction of joint compounds in the construction industry. The industry has yet to see a major breakthrough in sustainability or health impact that would benefit from using a new joint compound technology. Joint compounds typically contain synthetic materials and chemicals that require disposal in a landfill. Thus, there has been an unmet need to develop compounds with either recycled content or biodegradable materials that can reduce the environmental impact of these products. While the construction industry is seeing significant advancements in sustainable materials, the same advance is lacking regarding joint compounds. Green building initiatives tend to concentrate on insulation, roofing, timber, siding, and flooring rather than on joint compounds, aside from reduction of volatile organic compounds (VOCs) and dust control.

In contrast, the present disclosure provides a construction material that stands to have an immediate and positive impact on the environment and climate. In some embodiments, the disclosed construction materials contain substantially no gypsum. It can sequester carbon (carbon dioxide) more than one way, for example, in three or four different ways at different rates. The disclosed construction materials can sequester carbon for more than five years. In the presence of light, some of the disclosed construction material can continue to sequester carbon for the life of the products. In addition to carbon sequestration, material attributes include, but are not limited to, sound dampening, mold resistance, insulation, tensile strength, and fire retardancy. The disclosed construction materials can be self-cleaning and remove additional airborne bacteria and pollutants. In addition, the disclosed construction materials can use abundant natural materials, including recycled materials. At the end of its use, these construction materials can be recycled at substantially full strength or can be used as sustainable land filling.

Another area in which the disclosed construction materials excel is installer's health. There may be severe health risks due to inhalation of crystalline silica dust, a byproduct in some, if not all, existing joint compounds when the construction materials are sanded during installation. The connection between crystalline silica exposure and severe health conditions is well-documented in medical journals and government reports. The known health conditions that may be caused by the inhalation of crystalline silica dust include silicosis, lung cancer, and COPD. There are regulations imposed for PPE, high insurance premiums or denial of coverage, as a result of the exposure to crystalline silica dust.

Similarly, current construction material may affect occupant's health. Once applied, existing joint compounds may contain harmful chemicals, such as formaldehyde, which is a known carcinogen. Additionally, these joint compounds may include other VOCs that contribute to indoor air pollution and can have long-term environmental effects, potentially affecting the health of building occupants, particularly in poorly ventilated spaces. If the construction material is ever sanded or disturbed after application, it can release crystalline silica, or greater amounts of VOCs, leading to further health risks even after work is completed. Occupants in buildings where joint compound has contributed to mold growth may experience symptoms ranging from mild irritation to severe respiratory distress, depending on their level of exposure and sensitivity. After the construction materials comprising the joint compounds are dumped to a landfill, they continue to off-gas harmful VOCs.

Accordingly, there is an unmet need to improve the formulations of construction materials, including those of joint compounds. The present disclosure provides construction materials that do not contain or do not contain a detectable amount of crystalline silica, formaldehyde, or other harmful ingredients. Most, if not all, ingredients of the disclosed construction materials are harmless, do not produce substantially or detectable amounts of VOCs, and substantially no off gassing. There is no or substantially no harmful chemicals or indoor air pollution caused by the disclosed construction materials. The disclosed construction materials can fight mold growth, among other things.

Provided herein is a building material composition. In some embodiments, the building material composition described herein absorbs a greenhouse gas (e.g., carbon dioxide). In some embodiments, the building material composition described herein absorbs other airborne pollutants. In some embodiments, the building material composition described herein absorbs carbon dioxide, such as during a use described herein. In some embodiments, the building material composition described herein comprises magnesium oxide. In some embodiments, the building material composition described herein comprises a lime material. In some embodiments, the building material composition described herein comprises a lime material comprising a calcium oxide. In some embodiments, the building material composition described herein comprises a lime material comprising a calcium hydroxide. In some embodiments, the building material composition described herein comprises a lime material comprising a calcium oxide and calcium hydroxide. In some embodiments, the building material composition described herein comprises a pozzolan. In some embodiments, the building material composition described herein comprises a pozzolan comprising rice husk ash, coconut ash, ceramic ash, fly ash, vitrified calcium aluminio-silicate, blast furnace slag, ground granulated blast-furnace slag (GGBFS), zeolites, diatomaceous earth, silica fume, amorphous aluminosilicate, glass phase pozzolan, fume silica, metakaolin, calcinated diatomaceous earth, biochar, geopolymers, kaolinitic clays, volcanic ash, silica fume, pozzolanic lime, precipitated silica, carbon nanotubes, calcinated silicate pozzolan, synthetic pozzolan, or pozzolan powders, or a combination thereof. In some embodiments, the building material composition described herein comprises a pozzolan comprising at least one material selected from the group consisting of silica fume, amorphous aluminosilicate, vitrified calcium aluminio-silicate, glass-phase pozzolan, and volcanic ash. In some embodiments, the building material composition comprises gypsum. In some embodiments, the building material composition comprises gypsum at a concentration no more than 1.5% by weight of the building material composition.

In some embodiments, the building material composition further comprises at least one material selected from the group consisting of: filler, titanium dioxide, earthen material, rheology modifier, thickener, cementitious material, fiber, netting, clay, biocide, and dispersant. Unless expressly stated, the terms used herein have their regular meanings to a person skilled in the art.

As used herein, the terms “building material” or “construction material” generally refer to any substance used to construct buildings or other structures, such as bridges. Some common building materials include wood, brick, concrete, etc. It is appreciated by those skilled in the art that these common building materials are also used for purposes other than constructing buildings or other structures. For example, wood, brick, or concrete can be used for furnishings or decoration. The term building material, as described herein, is meant to capture this broader analogous use, as is appreciated by those skilled in the art.

As used herein, the term “pozzolan” generally refer to rice husk ash, coconut ash, ceramic ash, fly ash, vitrified calcium aluminio-silicate, blast furnace slag, ground granulated blast-furnace slag (GGBFS), zeolites, diatomaceous earth, silica fume, amorphous aluminosilicate, glass phase pozzolan, fume silica, metakaolin, calcinated diatomaceous earth, biochar, geopolymers, kaolinitic clays, volcanic ash, silica fume, pozzolanic lime, precipitated silica, carbon nanotubes, calcinated silicate pozzolan, synthetic pozzolan, or pozzolan powders (e.g., glass, brick).

In some embodiments, the building material described herein comprises brick. In some embodiments, the building material described herein comprises pourable construction medium. In some embodiments, the building material described herein comprises pourable cement. In some embodiments, the building material described herein comprises formable construction medium. In some embodiments, the building material described herein comprises casting medium. In some embodiments, the building material described herein comprises 3D printing medium. In some embodiments, the building material described herein comprises joint compound. In some embodiments, the building material described herein comprises furniture. In some embodiments, the building material described herein comprises home goods. In some embodiments, the building material described herein comprises sculpture. In some embodiments, the building material described herein comprises ornamental use. In some embodiments, the building material described herein comprises cast architectural products. In some embodiments, the building material described herein comprises wall paneling. In some embodiments, the building material described herein comprises wall board. In some embodiments, the building material described herein comprises tile. In some embodiments, the building material described herein comprises floor tile. In some embodiments, the building material described herein comprises wall tile. In some embodiments, the building material described herein comprises outdoor flooring and cast outdoor walls (e.g., those along freeways, noise barriers, cast-in-place retaining walls, pre-cast retaining walls, etc.). In some embodiments, the building material described herein comprises paving material. In some embodiments, the building material described herein comprises acoustical paneling. In some embodiments, the building material described herein comprises a wall coating. In some embodiments, the building material described herein comprises a ceiling coating. In some embodiments, the building material described herein comprises a floor coating. In some embodiments, the building material described herein comprises an outdoor coating. In some embodiments, the building material described herein comprises plaster. In some embodiments, the building material described herein comprises a pigment. In some embodiments, the building material described herein comprises pigmented plaster. In some embodiments, the building material described herein comprises pigmented compound. In some embodiments, the building material described herein comprises drywall mud. In some embodiments, the building material described herein comprises taping mud. In some embodiments, the building material described herein comprises drywall mud topping. In some embodiments, the building material described herein comprises stucco. In some embodiments, the building material described herein comprises submersible cast products. In some embodiments, the building material described herein comprises partially submerged cast products. In some embodiments, the building material described herein comprises a marine wall. In some embodiments, the building material described herein comprises a sea wall. In some embodiments, the building material described herein comprises an artificial reef. In some embodiments, the building material described herein comprises marine use. For underwater operations (e.g., sea walls, offshore drilling, artificial reef, etc.), magnesium hydroxide is preferably used in the formulation. Thus, for all the formulations disclosed here, the ingredient of magnesium oxide can be replaced with magnesium hydroxide to provide the corresponding formulations for underwater operations.

The building material composition, described herein, is a composition which may be suitable for use as a building material as described herein. Use as a building material described herein is not restrictive to the building material composition described herein. It is understood that embodiments of the building material composition described herein finding use outside of those as a building material described herein are still captured by the disclosure provided.

A greenhouse gas is a gas that absorbs and re-emits infrared radiation, in a process called the greenhouse effect. An example of greenhouse gasses are carbon dioxide, methane, nitrous oxide, water vapor, and perfluorocarbons. Greenhouse gasses, through the greenhouse effect, can contribute to an increase in global temperature by absorbing and re-emitting infrared (heat) radiation which would otherwise leave the system as radiation to outer space. As such, controlling the concentration of greenhouse gasses in the atmosphere is a key global effort, to aide in mitigation of unregulated increases in atmospheric temperature.

In some embodiments, the building material composition comprises active ingredients to absorb greenhouse gasses. In some embodiments, the building material composition comprises active ingredients to absorb carbon dioxide. In some embodiments, the building material composition comprises active ingredients to absorb carbon dioxide such as lime material. In some embodiments, the building material composition comprises active ingredients to absorb carbon dioxide such as lime material comprising calcium oxide. In some embodiments, the building material composition comprises active ingredients to absorb carbon dioxide such as lime material comprising calcium hydroxide. In some embodiments, the building material composition comprises active ingredients to absorb carbon dioxide such as magnesium oxide. In some embodiments, the building material composition comprises active ingredients to absorb carbon dioxide such as magnesium hydroxide. In some embodiments, the building material composition comprises active ingredients to absorb carbon dioxide such as calcium oxide. In some embodiments, the building material composition comprises active ingredients to absorb carbon dioxide such as calcium hydroxide. In some embodiments, the building material composition comprises active ingredients to absorb carbon dioxide such as titanium dioxide. In some embodiments, the building material composition comprises active ingredients to absorb carbon dioxide such as titanium dioxide further comprising ultraviolet light. In some embodiments, the building material composition comprises additional active ingredients appreciated by those skilled in the art to absorb carbon dioxide.

In some embodiments, the building material composition described herein provides utility during a use described herein. Said use described herein may refer to the building material composition throughout its manufacture, application, installation, lifetime, and disposal. As an example, a building material composition described herein comprising recycled, low carbon, carbon neutral, or compostable material provides utility during manufacture by reducing the carbon footprint of the building material compared to the manufacture of comparable building materials not comprising recycled, low carbon, carbon neutral, or compostable material. As another example, a building material composition described herein comprising a controlled amount of hazardous materials commonly found in building materials provides utility by improving working conditions during application and installation. As another example, a building material composition described herein comprising materials to absorb greenhouse gasses provides utility during its lifetime through the absorption of greenhouse gasses. As another example, a building material composition described herein comprising recyclable or compostable material such that the building material composition is recyclable or compostable at the end of its lifetime provides utility by eliminating the need for disposal in a landfill. As another example, a building material composition described herein comprising soil enhancing minerals such that it may be used as a soil enhancing additive at the end of its lifetime provides utility both by eliminating the need for disposal in a landfill and providing soil enhancement.

Magnesium oxide, as described herein, undergoes a carbonation reaction in the presence of carbon dioxide to form a stable magnesium carbonate compound. In some embodiments, the magnesium oxide described herein is a magnesium oxide. In some embodiments, the magnesium oxide described herein is a magnesium oxide powder. In some embodiments, the magnesium oxide described herein is a magnesium oxide containing mineral. In some embodiments, the magnesium oxide described herein is a powdered magnesium oxide containing minerals. In some embodiments, magnesium oxide as described herein is any metal oxide which undergoes a carbonation reaction in the presence of carbon dioxide to form a stable insoluble carbonate. In some embodiments, magnesium oxide as described herein is any metal oxide containing mineral which undergoes a carbonation reaction in the presence of carbon dioxide to form a stable insoluble carbonate.

Magnesium hydroxide, as described herein, undergoes a carbonation reaction in the presence of carbon dioxide to form a stable magnesium carbonate compound. In some embodiments, the magnesium hydroxide described herein is a magnesium hydroxide powder. In some embodiments, the magnesium hydroxide described herein is a magnesium hydroxide containing mineral. In some embodiments, the magnesium hydroxide described herein is a powdered magnesium hydroxide containing minerals. In some embodiments, magnesium hydroxide as described herein is any metal hydroxide which undergoes a carbonation reaction in the presence of carbon dioxide to form a stable insoluble carbonate. In some embodiments, magnesium hydroxide as described herein is any metal hydroxide containing mineral which undergoes a carbonation reaction in the presence of carbon dioxide to form a stable insoluble carbonate. When the formulations disclosed herein are for underwater operations (e.g., sea walls, offshore drilling, etc.), magnesium hydroxide is preferably used to replace magnesium oxide in the formulation. Thus, for all the formulations disclosed here, the ingredient of magnesium oxide can be replaced with magnesium hydroxide to provide the corresponding formulations for underwater operations.

Lime material, as described herein, generally refers to a mineral comprising calcium oxide and calcium hydroxide. Lime material, as described herein, may refer to a mineral comprising calcium oxide. Lime material, as described herein, may refer to a mineral comprising calcium hydroxide. Lime material, as described herein, may refer to a refined compound comprising calcium oxide and calcium hydroxide. Lime material, as described herein, may refer to a refined compound comprising calcium oxide. Lime material, as described herein, may refer to a refined compound comprising calcium hydroxide.

In some embodiments, lime material described herein comprises type N lime. In some embodiments, lime material described herein comprises type S lime. In some embodiments, lime material described herein comprises calcinated lime. In some embodiments, lime material described herein comprises hydrated lime. In some embodiments, lime material described herein comprises high calcium hydrated lime. In some embodiments, lime material described herein comprises hydraulic lime. In some embodiments, lime material described herein comprises natural hydraulic lime. In some embodiments, lime material described herein comprises lime putty. In some embodiments, lime material described herein comprises quicklime. In some embodiments, lime material described herein comprises fat lime. In some embodiments, lime material described herein comprises calcium carbonate. In some embodiments, lime material described herein comprises earthen lime plaster. In some embodiments, lime material described herein comprises slaked lime. In some embodiments, lime material described herein comprises earthen lime plasters comprising sand, clay, and fibers. In some embodiments, lime material described herein comprises calcium hydroxide. In some embodiments, lime material described herein comprises calcium hydroxide cation. In some embodiments, lime material described herein comprises calcium oxide.

Pozzolan, as described herein, may refer to a broad class of materials which react with water and calcium hydroxide to form compounds with cementitious properties. In some embodiments, pozzolan described herein comprises rice husk ash. In some embodiments, pozzolan described herein comprises fly ash. In some embodiments, pozzolan described herein comprises vitrified calcium alumino-silicate. In some embodiments, pozzolan described herein comprises blast furnace slag. In some embodiments, pozzolan described herein comprises ground granulated blast furnace slag (GGBFS). In some embodiments, pozzolan described herein comprises fume silica. In some embodiments, pozzolan described herein comprises metakaolin. In some embodiments, pozzolan described herein comprises volcanic tuff. In some embodiments, pozzolan described herein comprises calcinated diatomaceous earth. In some embodiments, pozzolan described herein comprises kaolinitic clays. In some embodiments, pozzolan described herein comprises volcanic ash. In some embodiments, pozzolan described herein comprises silica fume. In some embodiments, pozzolan described herein comprises wet silica fume. In some embodiments, pozzolan described herein comprises dry silica fume. In some embodiments, pozzolan described herein comprises pozzolanic lime. In some embodiments, pozzolan described herein comprises precipitated silica. In some embodiments, pozzolan described herein comprises carbon nanotubes. In some embodiments, pozzolan described herein comprises burned organic matter residues. In some embodiments, pozzolan described herein comprises burned organic matter residues rich in silica. In some embodiments, pozzolan described herein comprises natural pozzolans. In some embodiments, pozzolan described herein comprises artificial pozzolans. In some embodiments, pozzolan described herein comprises volcanic rock. In some embodiments, pozzolan described herein comprises rhyolite. In some embodiments, pozzolan described herein comprises trass. In some embodiments, pozzolan described herein comprises Santorinian Earth. In some embodiments, pozzolan described herein comprises amorphous aluminosilicate. In some embodiments, pozzolan described herein comprises glass-phase pozzolan. In some embodiments, pozzolan described herein comprises cementitious materials described herein.

In some embodiments, pozzolan described herein comprises at least one material selected from the group consisting of silica fume, amorphous aluminosilicate, glass-phase pozzolan, and volcanic ash.

In some embodiments, the building material composition described herein comprises gypsum in controlled quantities. Gypsum is a known hazardous material and is present in high quantities in many current building materials.

In some embodiments, the building material composition described herein contains gypsum at a concentration no more than 0% by weight to 10% by weight. In some embodiments, the building material composition described herein contains gypsum at a concentration no more than 0% by weight to 0.001% by weight, 0% by weight to 0.005% by weight, 0% by weight to 0.01% by weight, 0% by weight to 0.05% by weight, 0% by weight to 0.1% by weight, 0% by weight to 0.25% by weight, 0% by weight to 0.5% by weight, 0% by weight to 1% by weight, 0% by weight to 1.5% by weight, 0% by weight to 5% by weight, 0% by weight to 10% by weight, 0.001% by weight to 0.005% by weight, 0.001% by weight to 0.01% by weight, 0.001% by weight to 0.05% by weight, 0.001% by weight to 0.1% by weight, 0.001% by weight to 0.25% by weight, 0.001% by weight to 0.5% by weight, 0.001% by weight to 1% by weight, 0.001% by weight to 1.5% by weight, 0.001% by weight to 5% by weight, 0.001% by weight to 10% by weight, 0.005% by weight to 0.01% by weight, 0.005% by weight to 0.05% by weight, 0.005% by weight to 0.1% by weight, 0.005% by weight to 0.25% by weight, 0.005% by weight to 0.5% by weight, 0.005% by weight to 1% by weight, 0.005% by weight to 1.5% by weight, 0.005% by weight to 5% by weight, 0.005% by weight to 10% by weight, 0.01% by weight to 0.05% by weight, 0.01% by weight to 0.1% by weight, 0.01% by weight to 0.25% by weight, 0.01% by weight to 0.5% by weight, 0.01% by weight to 1% by weight, 0.01% by weight to 1.5% by weight, 0.01% by weight to 5% by weight, 0.01% by weight to 10% by weight, 0.05% by weight to 0.1% by weight, 0.05% by weight to 0.25% by weight, 0.05% by weight to 0.5% by weight, 0.05% by weight to 1% by weight, 0.05% by weight to 1.5% by weight, 0.05% by weight to 5% by weight, 0.05% by weight to 10% by weight, 0.1% by weight to 0.25% by weight, 0.1% by weight to 0.5% by weight, 0.1% by weight to 1% by weight, 0.1% by weight to 1.5% by weight, 0.1% by weight to 5% by weight, 0.1% by weight to 10% by weight, 0.25% by weight to 0.5% by weight, 0.25% by weight to 1% by weight, 0.25% by weight to 1.5% by weight, 0.25% by weight to 5% by weight, 0.25% by weight to 10% by weight, 0.5% by weight to 1% by weight, 0.5% by weight to 1.5% by weight, 0.5% by weight to 5% by weight, 0.5% by weight to 10% by weight, 1% by weight to 1.5% by weight, 1% by weight to 5% by weight, 1% by weight to 10% by weight, 1.5% by weight to 5% by weight, 1.5% by weight to 10% by weight, or 5% by weight to 10% by weight. In some embodiments, the building material composition described herein contains gypsum at a concentration no more than 0% by weight, 0.001% by weight, 0.005% by weight, 0.01% by weight, 0.05% by weight, 0.1% by weight, 0.25% by weight, 0.5% by weight, 1% by weight, 1.5% by weight, 5% by weight, or 10% by weight. In some embodiments, the building material composition described herein contains gypsum at a concentration no more than at least 0% by weight, 0.001% by weight, 0.005% by weight, 0.01% by weight, 0.05% by weight, 0.1% by weight, 0.25% by weight, 0.5% by weight, 1% by weight, 1.5% by weight, or 5% by weight. In some embodiments, the building material composition described herein contains gypsum at a concentration no more than at most 0.001% by weight, 0.005% by weight, 0.01% by weight, 0.05% by weight, 0.1% by weight, 0.25% by weight, 0.5% by weight, 1% by weight, 1.5% by weight, 5% by weight, or 10% by weight.

In some embodiments, the building material composition described herein comprises crystalline silica in controlled quantities. Crystalline silica is a known hazardous material and is present in high quantities in many current building materials.

In some embodiments, the building material composition described herein contains crystalline silica at a concentration no more than 0% by weight to 10% by weight. In some embodiments, the building material composition described herein contains crystalline silica at a concentration no more than 0% by weight to 0.001% by weight, 0% by weight to 0.005% by weight, 0% by weight to 0.01% by weight, 0% by weight to 0.05% by weight, 0% by weight to 0.1% by weight, 0% by weight to 0.25% by weight, 0% by weight to 0.5% by weight, 0% by weight to 1% by weight, 0% by weight to 1.5% by weight, 0% by weight to 5% by weight, 0% by weight to 10% by weight, 0.001% by weight to 0.005% by weight, 0.001% by weight to 0.01% by weight, 0.001% by weight to 0.05% by weight, 0.001% by weight to 0.1% by weight, 0.001% by weight to 0.25% by weight, 0.001% by weight to 0.5% by weight, 0.001% by weight to 1% by weight, 0.001% by weight to 1.5% by weight, 0.001% by weight to 5% by weight, 0.001% by weight to 10% by weight, 0.005% by weight to 0.01% by weight, 0.005% by weight to 0.05% by weight, 0.005% by weight to 0.1% by weight, 0.005% by weight to 0.25% by weight, 0.005% by weight to 0.5% by weight, 0.005% by weight to 1% by weight, 0.005% by weight to 1.5% by weight, 0.005% by weight to 5% by weight, 0.005% by weight to 10% by weight, 0.01% by weight to 0.05% by weight, 0.01% by weight to 0.1% by weight, 0.01% by weight to 0.25% by weight, 0.01% by weight to 0.5% by weight, 0.01% by weight to 1% by weight, 0.01% by weight to 1.5% by weight, 0.01% by weight to 5% by weight, 0.01% by weight to 10% by weight, 0.05% by weight to 0.1% by weight, 0.05% by weight to 0.25% by weight, 0.05% by weight to 0.5% by weight, 0.05% by weight to 1% by weight, 0.05% by weight to 1.5% by weight, 0.05% by weight to 5% by weight, 0.05% by weight to 10% by weight, 0.1% by weight to 0.25% by weight, 0.1% by weight to 0.5% by weight, 0.1% by weight to 1% by weight, 0.1% by weight to 1.5% by weight, 0.1% by weight to 5% by weight, 0.1% by weight to 10% by weight, 0.25% by weight to 0.5% by weight, 0.25% by weight to 1% by weight, 0.25% by weight to 1.5% by weight, 0.25% by weight to 5% by weight, 0.25% by weight to 10% by weight, 0.5% by weight to 1% by weight, 0.5% by weight to 1.5% by weight, 0.5% by weight to 5% by weight, 0.5% by weight to 10% by weight, 1% by weight to 1.5% by weight, 1% by weight to 5% by weight, 1% by weight to 10% by weight, 1.5% by weight to 5% by weight, 1.5% by weight to 10% by weight, or 5% by weight to 10% by weight. In some embodiments, the building material composition described herein contains crystalline silica at a concentration no more than 0% by weight, 0.001% by weight, 0.005% by weight, 0.01% by weight, 0.05% by weight, 0.1% by weight, 0.25% by weight, 0.5% by weight, 1% by weight, 1.5% by weight, 5% by weight, or 10% by weight. In some embodiments, the building material composition described herein contains crystalline silica at a concentration no more than at least 0% by weight, 0.001% by weight, 0.005% by weight, 0.01% by weight, 0.05% by weight, 0.1% by weight, 0.25% by weight, 0.5% by weight, 1% by weight, 1.5% by weight, or 5% by weight. In some embodiments, the building material composition described herein contains crystalline silica at a concentration no more than at most 0.001% by weight, 0.005% by weight, 0.01% by weight, 0.05% by weight, 0.1% by weight, 0.25% by weight, 0.5% by weight, 1% by weight, 1.5% by weight, 5% by weight, or 10% by weight.

In some embodiments, the building material composition described herein comprises magnesium oxide described herein, and lime material described herein.

In some embodiments, the building material composition described herein comprises magnesium oxide described herein, lime material described herein, and pozzolan described herein.

In some embodiments, the building material composition described herein comprises lime material described herein, and pozzolan described herein.

In some embodiments, the building material composition described herein comprises magnesium oxide described herein, and pozzolan described herein.

In some embodiments, the building material composition described herein comprises magnesium oxide described herein, lime material described herein, pozzolan described herein, and gypsum described herein.

In some embodiments, the building material composition described herein comprises magnesium oxide described herein, and gypsum described herein,

In some embodiments, the building material composition described herein comprises lime material described herein, and gypsum described herein.

In some embodiments, the building material composition described herein comprises pozzolan described herein, and gypsum described herein.

In some embodiments, the building material composition described herein comprises magnesium oxide described herein, pozzolan described herein, and gypsum described herein.

In some embodiments, the building material composition described herein comprises magnesium oxide described herein, lime material described herein, and gypsum described herein.

In some embodiments, the building material composition described herein comprises lime material described herein, pozzolan described herein, and gypsum described herein.

In some embodiments, the building material composition described herein further comprises filler described herein. In some embodiments, filler described herein comprises microspheres. In some embodiments, filler described herein comprises foam beads. In some embodiments, filler described herein comprises ceramic beads. In some embodiments, filler described herein comprises microbubbles. In some embodiments, filler described herein comprises glass bubbles. In some embodiments, filler described herein comprises beads. In some embodiments, filler described herein comprises beads and the like. In some embodiments, filler described herein comprises recycled glass beads. In some embodiments, filler described herein comprises perlite. In some embodiments, filler described herein comprises expanded clay. In some embodiments, filler described herein comprises vermiculite. In some embodiments, filler described herein comprises foamed silica. In some embodiments, filler described herein comprises kaolin. In some embodiments, filler described herein comprises nepheline syenite. In some embodiments, filler described herein comprises silicon dioxide. In some embodiments, filler described herein comprises aluminum oxide. In some embodiments, filler described herein comprises recycled glass. In some embodiments, filler described herein comprises pumice. In some embodiments, filler described herein comprises fly ash cenospheres. In some embodiments, filler described herein comprises diatomite. In some embodiments, filler described herein comprises diatomaceous earth. In some embodiments, filler described herein comprises foamed amorphous silica. In some embodiments, filler described herein comprises natural pumice microspheres. In some embodiments, filler described herein comprises zeolite micronized foam. In some embodiments, filler described herein comprises non-toxic zeolite micronized foam. In some embodiments, filler described herein comprises nanocellulose. In some embodiments, filler described herein comprises microfibrillated cellulose. In some embodiments, filler described herein comprises cellulose. In some embodiments, filler described herein comprises biochar. In some embodiments, filler described herein comprises biochar microspheres. In some embodiments, filler described herein comprises calcium carbonate. In some embodiments, filler described herein comprises calcium carbonate microspheres. In some embodiments, filler described herein comprises perlite microspheres. In some embodiments, filler described herein comprises cork. In some embodiments, filler described herein comprises wood pellets. In some embodiments, filler described herein comprises wood fibers. In some embodiments, filler described herein comprises rice husk. In some embodiments, filler described herein comprises rice husk granules. In some embodiments, filler described herein comprises biochar pellets. In some embodiments, filler described herein comprises crushed shells. In some embodiments, filler described herein comprises crushed oyster shells. In some embodiments, filler described herein comprises crushed walnut shells. In some embodiments, filler described herein comprises crushed shellfish shells. In some embodiments, filler described herein comprises coarse calcium carbonate. In some embodiments, filler described herein comprises natural gravel. In some embodiments, filler described herein comprises natural sand. In some embodiments, filler described herein comprises crushed mineral. In some embodiments, filler described herein comprises powdered mineral. In some embodiments, filler described herein comprises mineral pellets. In some embodiments, filler described herein comprises coarse pumice. In some embodiments, filler described herein comprises microspheres comprising at least one of natural pumice microspheres, biochar microspheres, calcium carbonate microspheres, or perlite microspheres.

In some embodiments, the building material composition described herein further comprises titanium dioxide described herein. In some embodiments, titanium dioxide described herein comprises titanium dioxide. In some embodiments, titanium dioxide described herein comprises titanium dioxide powder. In some embodiments, titanium dioxide described herein comprises titanium dioxide pigment. In some embodiments, titanium dioxide described herein comprises a mineral comprising titanium dioxide. In some embodiments, titanium dioxide described herein comprises a mineral powder comprising titanium dioxide. In some embodiments, titanium dioxide described herein comprises refined titanium dioxide. In some embodiments, titanium dioxide described herein comprises naturally refined titanium dioxide. In some embodiments, titanium dioxide described herein comprises chemically refined titanium dioxide. In some embodiments described herein, titanium dioxide described herein further comprises other titanium oxides. In some embodiments, titanium dioxide described herein comprises other metal oxides.

In some embodiments, the building material composition described herein further comprises earthen material described herein. In some embodiments, earthen material described herein comprises diatomaceous earth. In some embodiments, earthen material described herein comprises bentonite clay. In some embodiments, earthen material described herein comprises silica sand. In some embodiments, earthen material described herein comprises silica. In some embodiments, earthen material described herein comprises zeolites. In some embodiments, earthen material described herein comprises other earthen material.

In some embodiments, the building material composition described herein further comprises rheology modifiers described herein. In some embodiments, rheology modifiers described herein comprises hydroxypropyl methyl cellulose (HPMC). In some embodiments, rheology modifiers described herein comprises methyl cellulose (MC). In some embodiments, rheology modifiers described herein comprises hydroxyethyl cellulose (HEC). In some embodiments, rheology modifiers described herein comprises modified hydroxyethyl cellulose. In some embodiments, rheology modifiers described herein comprises hydroxyethyl methylcellulose (HEMC). In some embodiments, rheology modifiers described herein comprises methyl hydroxyethyl cellulose (MHEC). In some embodiments, rheology modifiers described herein comprises anionic cellulose ethers. In some embodiments, rheology modifiers described herein comprises nonionic cellulose ethers. In some embodiments, rheology modifiers described herein comprises crosslinked cellulose ethers. In some embodiments, rheology modifiers described herein comprises hydrophobically modified cellulose ethers. In some embodiments, rheology modifiers described herein comprises low-viscosity cellulose ethers. In some embodiments, rheology modifiers described herein comprises high-viscosity cellulose ethers. In some embodiments, rheology modifiers described herein comprises ethyl cellulose (EC). In some embodiments, rheology modifiers described herein comprises carrageenan. In some embodiments, rheology modifiers described herein comprises tragacanth gum. In some embodiments, rheology modifiers described herein comprises native starches. In some embodiments, rheology modifiers described herein comprises corn starch. In some embodiments, rheology modifiers described herein comprises potato starch. In some embodiments, rheology modifiers described herein comprises tapioca starch. In some embodiments, rheology modifiers described herein comprises chitosan. In some embodiments, rheology modifiers described herein comprises carboxymethyl cellulose. In some embodiments, rheology modifiers described herein comprises guar gum. In some embodiments, rheology modifiers described herein comprises xanthan gum. In some embodiments, rheology modifiers described herein comprises pectin. In some embodiments, rheology modifiers described herein comprises carob gum. In some embodiments, rheology modifiers described herein comprises hydrolyzed polyvinyl alcohol. In some embodiments, rheology modifiers described herein comprises polymers. In some embodiments, rheology modifiers described herein comprises gum acacia. In some embodiments, rheology modifiers described herein comprises bentonite clay. In some embodiments, rheology modifiers described herein comprises alginates. In some embodiments, rheology modifiers described herein comprises agar-agar. In some embodiments, rheology modifiers described herein comprises non-etherified starch agent variants. In some embodiments, rheology modifiers described herein comprises rice bran extracts. In some embodiments, rheology modifiers described herein comprises thickener described herein.

In some embodiments, the building material composition described herein further comprises thickener described herein. In some embodiments, the thickener described herein comprises hydrocolloids. In some embodiments, the thickener described herein comprises gelatinized starch. In some embodiments, the thickener described herein comprises starch ethers. In some embodiments, the thickener described herein comprises cellulose based starch. In some embodiments, the thickener described herein comprises modified starch. In some embodiments, the thickener described herein comprises tapioca starch. In some embodiments, the thickener described herein comprises corn starch. In some embodiments, the thickener described herein comprises potato starch. In some embodiments, the thickener described herein comprises native starches. In some embodiments, the thickener described herein comprises pectin. In some embodiments, the thickener described herein comprises carboxymethyl cellulose. In some embodiments, the thickener described herein comprises agar-agar. In some embodiments, the thickener described herein comprises rheology modifiers as described herein.

In some embodiments, the building material composition described herein further comprises cementitious materials described herein. In some embodiments, the cementitious materials described herein further comprises binders. In some embodiments, the cementitious materials described herein further comprises fly ash. In some embodiments, the cementitious materials described herein further comprises geopolymers. In some embodiments, the cementitious materials described herein further comprises ground granulated blast furnace slag (GGBFS). In some embodiments, the cementitious materials described herein further comprises rice husk ash. In some embodiments, the cementitious materials described herein further comprises adobe. In some embodiments, the cementitious materials described herein further comprises cob. In some embodiments, the cementitious materials described herein further comprises metakaolin. In some embodiments, the cementitious materials described herein further comprises geopolymers. In some embodiments, the cementitious materials described herein further comprises calcium sulfoaluminate. In some embodiments, the cementitious materials described herein further comprises calcium aluminate. In some embodiments, the cementitious materials described herein further comprises calcium aluminate cement. In some embodiments, the cementitious materials described herein further comprises magnesium oxide. In some embodiments, the cementitious materials described herein further comprises aluminum oxide. In some embodiments, the cementitious materials described herein further comprises titanium dioxide. In some embodiments, the cementitious materials described herein further comprises metal oxides. In some embodiments, the cementitious materials described herein further comprises nepheline syenite. In some embodiments, the cementitious materials described herein further comprises kaolin. In some embodiments, the cementitious materials described herein further comprises bio cements. In some embodiments, the cementitious materials described herein further comprises cement. In some embodiments, the cementitious materials described herein further comprises pozzolan described herein.

In some embodiments, the building material composition described herein further comprises fiber described herein. In some embodiments, fiber described herein comprises flax. In some embodiments, fiber described herein comprises hemp. In some embodiments, fiber described herein comprises cotton. In some embodiments, fiber described herein comprises coconut. In some embodiments, fiber described herein comprises coconut fiber. In some embodiments, fiber described herein comprises coconut husk. In some embodiments, fiber described herein comprises coconut coir. In some embodiments, fiber described herein comprises bamboo. In some embodiments, fiber described herein comprises bamboo waste. In some embodiments, fiber described herein comprises sugar cane. In some embodiments, fiber described herein comprises sugar cane waste. In some embodiments, fiber described herein comprises bagasse. In some embodiments, fiber described herein comprises rice husk. In some embodiments, fiber described herein comprises straw. In some embodiments, fiber described herein comprises other abundant agricultural waste. In some embodiments, fiber described herein comprises agricultural waste. In some embodiments, fiber described herein comprises jute. In some embodiments, fiber described herein comprises netting described herein.

In some embodiments, the building material composition described herein further comprises netting described herein. In some embodiments, netting described herein comprises jute. In some embodiments, netting described herein comprises coconut coir. In some embodiments, netting described herein comprises coconut husk. In some embodiments, netting described herein comprises coconut fiber. In some embodiments, netting described herein comprises geotextiles. In some embodiments, netting described herein comprises sisal. In some embodiments, netting described herein comprises flax. In some embodiments, netting described herein comprises wool. In some embodiments, netting described herein comprises wool matting. In some embodiments, netting described herein comprises fiber described herein.

In some embodiments, the building material composition described herein further comprises clay. In some embodiments, clay described herein comprises clay mixtures. In some embodiments, clay described herein comprises kaolinite. In some embodiments, clay described herein comprises cob. In some embodiments, clay described herein comprises adobe. In some embodiments, clay described herein comprises straw. In some embodiments, clay described herein comprises hemp. In some embodiments, clay described herein comprises fibrous plasters. In some embodiments, clay described herein comprises geopolymers. In some embodiments, clay described herein comprises geopolymer clays. In some embodiments, clay described herein comprises amorphous geopolymer clays. In some embodiments, clay described herein comprises rammed earth. In some embodiments, clay described herein comprises crete. In some embodiments, clay described herein comprises papercrete. In some embodiments, clay described herein comprises hempcrete. In some embodiments, clay described herein comprises mycelium. In some embodiments, clay described herein comprises wood fiber. In some embodiments, clay described herein comprises wood fiber-based clays. In some embodiments, clay described herein comprises sandstone. In some embodiments, clay described herein comprises ash. In some embodiments, clay described herein comprises soil. In some embodiments, clay described herein comprises reclaimed soil. In some embodiments, clay described herein comprises crushed dust. In some embodiments, clay described herein comprises crushed brick dust. In some embodiments, clay described herein comprises crushed stone dust. In some embodiments, clay described herein comprises crushed mineral dust. In some embodiments, clay described herein comprises aggregate. In some embodiments, clay described herein comprises cellulose. In some embodiments, clay described herein comprises recycled cellulose. In some embodiments, clay described herein comprises expanded cork. In some embodiments, clay described herein comprises cork. In some embodiments, clay described herein comprises earthen material described herein. In some embodiments, clay described herein comprises fiber described herein. In some embodiments, clay described herein comprises netting described herein.

In some embodiments, the building material composition described herein further comprises biocides described herein. In some embodiments, biocides described herein comprises citric acid. In some embodiments, biocides described herein comprises boric acid. In some embodiments, biocides described herein comprises borax. In some embodiments, biocides described herein comprises agricultural waste. In some embodiments, biocides described herein comprises agricultural waste treated with borates. In some embodiments, biocides described herein comprises agricultural waste treated with boric acid. In some embodiments, biocides described herein comprises agricultural waste treated with bagasse. In some embodiments, biocides described herein comprises agricultural waste treated with sugar cane waste. In some embodiments, biocides described herein comprises agricultural waste treated with rice husk. In some embodiments, biocides described herein comprises agricultural waste treated with straw. In some embodiments, biocides described herein comprises borates. In some embodiments, biocides described herein comprises bagasse. In some embodiments, biocides described herein comprises sugar cane waste. In some embodiments, biocides described herein comprises rice husk. In some embodiments, biocides described herein comprises straw.

In some embodiments, the building material composition described herein further comprises agricultural waste described herein. In some embodiments, the agricultural waste described herein comprises agricultural waste treated with borates. In some embodiments, the agricultural waste described herein comprises agricultural waste treated with biocide described herein. In some embodiments, the agricultural waste described herein comprises agricultural waste treated with boric acid. In some embodiments, the agricultural waste described herein comprises borates. In some embodiments, the agricultural waste described herein comprises bagasse. In some embodiments, the agricultural waste described herein comprises sugar cane waste. In some embodiments, the agricultural waste described herein comprises rice husk. In some embodiments, the agricultural waste described herein comprises straw.

In some embodiments, the building material composition described herein further comprises dispersant described herein. In some embodiments, dispersants described herein comprise lignosulfonates. In some embodiments, dispersants described herein comprise saponins. In some embodiments, dispersants described herein comprise carboxymethyl starch. In some embodiments, dispersants described herein comprise guar gum. In some embodiments, dispersants described herein comprise xanthan gum.

In some embodiments, the building material composition described herein further comprises coatings described herein. In some embodiments, coatings described herein further comprises natural paints. In some embodiments, coatings described herein further comprises mineral coatings. In some embodiments, coatings described herein further comprises silicate paint. In some embodiments, coatings described herein further comprises casein paint. In some embodiments, coatings described herein further comprises natural casein paint. In some embodiments, coatings described herein further comprises cement paint. In some embodiments, coatings described herein further comprises natural cement paint. In some embodiments, coatings described herein further comprises titanium dioxide. In some embodiments, coatings described herein further comprises titanium dioxide coating. In some embodiments, coatings described herein further comprises pigments described herein.

In some embodiments, the building material composition described herein further comprises pigments described herein. In some embodiments, pigments described herein comprises titanium dioxide described herein. In some embodiments, pigments described herein comprises iron oxide. In some embodiments, pigments described herein comprises iron-based pigments. In some embodiments, pigments described herein comprises linseed-based pigments. In some embodiments, pigments described herein comprises earth pigments. In some embodiments, pigments described herein comprises minerals. In some embodiments, pigments described herein comprises mineral pigments. In some embodiments, pigments described herein comprises carbon-based pigments. In some embodiments, pigments described herein comprises chromium oxides. In some embodiments, pigments described herein comprises ultramarine. In some embodiments, pigments described herein comprises natural ultramarine. In some embodiments, pigments described herein comprises synthetic ultramarine. In some embodiments, pigments described herein comprises mica. In some embodiments, pigments described herein comprises mica-based pigments. In some embodiments, pigments described herein comprises pozzolanic lime. In some embodiments, pigments described herein comprises pozzolanic lime washes. In some embodiments, pigments described herein comprises plant-based dyes. In some embodiments, pigments described herein comprises plant-based pigments. In some embodiments, pigments described herein comprises clay-based colorants. In some embodiments, pigments described herein comprises natural oxides. In some embodiments, pigments described herein comprises natural nitrides. In some embodiments, pigments described herein comprises charcoal. In some embodiments, pigments described herein comprises burnt wood. In some embodiments, pigments described herein comprises plant-based charcoal. In some embodiments, pigments described herein comprises milk paint. In some embodiments, pigments described herein comprises natural minerals. In some embodiments, pigments described herein comprises rocks. In some embodiments, pigments described herein comprises vegetable oil. In some embodiments, pigments described herein comprises seed oil. In some embodiments, pigments described herein comprises natural tempera. In some embodiments, pigments described herein comprises tempera. In some embodiments, pigments described herein comprises biological pigments. In some embodiments, pigments described herein comprises biological dyes. In some embodiments, pigments described herein comprises algae. In some embodiments, pigments described herein comprises bacteria. In some embodiments, pigments described herein comprises algae derived pigment. In some embodiments, pigments described herein comprises algae derived dye. In some embodiments, pigments described herein comprises bacteria derived pigment. In some embodiments, pigments described herein comprises bacteria derived dye. In some embodiments, pigments described herein comprises geologically derived pigments.

Provided in some embodiments herein is a method of sequestering carbon dioxide from the environment comprising mixing a building material composition described herein to form a mixture. In some embodiments, said mixture comprises magnesium oxide, described herein. In some embodiments, said mixture comprises magnesium hydroxide, described herein. In some embodiments, said mixture comprises calcium oxide, described herein. In some embodiments, said mixture comprises calcium hydroxide, described herein. In some embodiments, exposing said mixture to an environment comprising carbon dioxide thereby sequesters at least a first portion of the carbon dioxide.

In some embodiments, a mixture described herein may be formed by combining the building material composition described herein with water.

In some embodiments, the mixture described herein comprises magnesium oxide described herein.

In some embodiments, the mixture described herein comprises magnesium hydroxide.

In some embodiments, the mixture described herein comprises lime material described herein.

In some embodiments, the mixture described herein comprises calcium hydroxide.

In some embodiments, the mixture described herein comprises magnesium oxide and magnesium hydroxide.

In some embodiments, the mixture described herein comprises magnesium oxide and calcium oxide.

In some embodiments, the mixture described herein comprises magnesium oxide and calcium hydroxide.

In some embodiments, the mixture described herein comprises magnesium hydroxide and calcium oxide.

In some embodiments, the mixture described herein comprises magnesium hydroxide and calcium hydroxide.

In some embodiments, the mixture described herein comprises calcium oxide and calcium hydroxide.

In some embodiments, the mixture described herein comprises magnesium oxide, magnesium hydroxide, and calcium oxide.

In some embodiments, the mixture described herein comprises magnesium oxide, magnesium hydroxide, and calcium hydroxide.

In some embodiments, the mixture described herein comprises magnesium oxide, calcium oxide, and calcium hydroxide.

In some embodiments, the mixture described herein comprises magnesium hydroxide, calcium oxide, and calcium hydroxide.

In some embodiments, the mixture described herein comprises magnesium oxide, magnesium hydroxide, calcium oxide, and calcium hydroxide.

In some embodiments, said method of sequestering carbon dioxide comprises carbonation. In some embodiments, said method of sequestering carbon dioxide comprises carbonation by magnesium oxide, described herein. In some embodiments, said method of sequestering carbon dioxide comprises carbonation by magnesium hydroxide, described herein. In some embodiments, said method of sequestering carbon dioxide comprises carbonation by calcium oxide. In some embodiments, said method of sequestering carbon dioxide comprises carbonation by calcium hydroxide.

In some embodiments, said method of sequestering carbon dioxide further comprises titanium dioxide. In some embodiments, said method of sequestering carbon dioxide further comprises titanium dioxide powder. In some embodiments, said method of sequestering carbon dioxide further comprises titanium dioxide pigment. In some embodiments, said method of sequestering carbon dioxide further comprises titanium dioxide coating. In some embodiments, said method of sequestering carbon dioxide further comprises titanium dioxide paint. In some embodiments, said method of sequestering carbon dioxide further comprises minerals comprising titanium dioxide. In some embodiments, said method of sequestering carbon dioxide further comprises mineral powder comprising titanium dioxide. In some embodiments, said method of sequestering carbon dioxide further comprises refined titanium dioxide. In some embodiments, said method of sequestering carbon dioxide further comprises naturally refined titanium dioxide. In some embodiments, said method of sequestering carbon dioxide further comprises chemically refined titanium dioxide.

In some embodiments, said method of sequestering carbon dioxide further comprises applying a titanium dioxide coating. In some embodiments, said method of sequestering carbon dioxide further comprises applying a titanium dioxide coating on the mixture. In some embodiments, said method of sequestering carbon dioxide further comprises applying a titanium dioxide coating on a partially dried mixture.

In some embodiments, the titanium dioxide coating described herein is breathable.

In some embodiments, said method of sequestering carbon dioxide further comprises titanium dioxide described herein as a component of the mixture described herein.

In some embodiments, said method of sequestering carbon dioxide further comprises catalysis of at least a second portion of carbon dioxide into a hydrocarbon by titanium dioxide, described herein. In some embodiments, said method of sequestering carbon dioxide further comprises catalysis of at least a second portion of carbon dioxide into a hydrocarbon in the presence of light by titanium dioxide, described herein. In some embodiments, said method of sequestering carbon dioxide further comprises catalysis of at least a second portion of carbon dioxide into a hydrocarbon in the presence of ultraviolet light by titanium dioxide, described herein. In some embodiments, said method of sequestering carbon dioxide further comprises catalysis of at least a second portion of carbon dioxide into a hydrocarbon by a titanium dioxide coating, described herein. In some embodiments, said method of sequestering carbon dioxide further comprises catalysis of at least a second portion of carbon dioxide into a hydrocarbon in the presence of light by a titanium dioxide coating, described herein. In some embodiments, said method of sequestering carbon dioxide further comprises catalysis of at least a second portion of carbon dioxide into a hydrocarbon in the presence of ultraviolet light by a titanium dioxide coating, described herein. In some embodiments, said method of sequestering carbon dioxide further comprises catalysis of at least a second portion of carbon dioxide into a hydrocarbon by at least part of the titanium dioxide, described herein. In some embodiments, said method of sequestering carbon dioxide further comprises catalysis of at least a second portion of carbon dioxide into a hydrocarbon in the presence of light by at least part of the titanium dioxide, described herein. In some embodiments, said method of sequestering carbon dioxide further comprises catalysis of at least a second portion of carbon dioxide into a hydrocarbon in the presence of ultraviolet light by at least part of the titanium dioxide, described herein.

### Example of a Building Material Composition

Provided herein is an example of a building material composition comprising magnesium oxide described herein present at a concentration of about 0.5% to about 50% by weight, lime described herein present at a concentration from about 25% to about 80% by weight, and pozzolan as described herein present at a concentration from about 0.5% to about 75% by weight.

In some embodiments, the building material composition comprises magnesium oxide present at a concentration of about 0.5% by weight to about 50% by weight. In some embodiments, the building material composition comprises magnesium oxide present at a concentration of about 0.5% by weight to about 1% by weight, about 0.5% by weight to about 5% by weight, about 0.5% by weight to about 10% by weight, about 0.5% by weight to about 15% by weight, about 0.5% by weight to about 20% by weight, about 0.5% by weight to about 25% by weight, about 0.5% by weight to about 30% by weight, about 0.5% by weight to about 35% by weight, about 0.5% by weight to about 40% by weight, about 0.5% by weight to about 45% by weight, about 0.5% by weight to about 50% by weight, about 1% by weight to about 5% by weight, about 1% by weight to about 10% by weight, about 1% by weight to about 15% by weight, about 1% by weight to about 20% by weight, about 1% by weight to about 25% by weight, about 1% by weight to about 30% by weight, about 1% by weight to about 35% by weight, about 1% by weight to about 40% by weight, about 1% by weight to about 45% by weight, about 1% by weight to about 50% by weight, about 5% by weight to about 10% by weight, about 5% by weight to about 15% by weight, about 5% by weight to about 20% by weight, about 5% by weight to about 25% by weight, about 5% by weight to about 30% by weight, about 5% by weight to about 35% by weight, about 5% by weight to about 40% by weight, about 5% by weight to about 45% by weight, about 5% by weight to about 50% by weight, about 10% by weight to about 15% by weight, about 10% by weight to about 20% by weight, about 10% by weight to about 25% by weight, about 10% by weight to about 30% by weight, about 10% by weight to about 35% by weight, about 10% by weight to about 40% by weight, about 10% by weight to about 45% by weight, about 10% by weight to about 50% by weight, about 15% by weight to about 20% by weight, about 15% by weight to about 25% by weight, about 15% by weight to about 30% by weight, about 15% by weight to about 35% by weight, about 15% by weight to about 40% by weight, about 15% by weight to about 45% by weight, about 15% by weight to about 50% by weight, about 20% by weight to about 25% by weight, about 20% by weight to about 30% by weight, about 20% by weight to about 35% by weight, about 20% by weight to about 40% by weight, about 20% by weight to about 45% by weight, about 20% by weight to about 50% by weight, about 25% by weight to about 30% by weight, about 25% by weight to about 35% by weight, about 25% by weight to about 40% by weight, about 25% by weight to about 45% by weight, about 25% by weight to about 50% by weight, about 30% by weight to about 35% by weight, about 30% by weight to about 40% by weight, about 30% by weight to about 45% by weight, about 30% by weight to about 50% by weight, about 35% by weight to about 40% by weight, about 35% by weight to about 45% by weight, about 35% by weight to about 50% by weight, about 40% by weight to about 45% by weight, about 40% by weight to about 50% by weight, or about 45% by weight to about 50% by weight. In some embodiments, the building material composition comprises magnesium oxide present at a concentration of about 0.5% by weight, about 1% by weight, about 5% by weight, about 10% by weight, about 15% by weight, about 20% by weight, about 25% by weight, about 30% by weight, about 35% by weight, about 40% by weight, about 45% by weight, or about 50% by weight. In some embodiments, the building material composition comprises magnesium oxide present at a concentration of at least about 0.5% by weight, about 1% by weight, about 5% by weight, about 10% by weight, about 15% by weight, about 20% by weight, about 25% by weight, about 30% by weight, about 35% by weight, about 40% by weight, or about 45% by weight. In some embodiments, the building material composition comprises magnesium oxide present at a concentration of at most about 1% by weight, about 5% by weight, about 10% by weight, about 15% by weight, about 20% by weight, about 25% by weight, about 30% by weight, about 35% by weight, about 40% by weight, about 45% by weight, or about 50% by weight.

In some embodiments, the building material composition comprises lime present at a concentration of about 25% by weight to about 80% by weight. In some embodiments, the building material composition comprises lime present at a concentration of about 25% by weight to about 30% by weight, about 25% by weight to about 35% by weight, about 25% by weight to about 40% by weight, about 25% by weight to about 45% by weight, about 25% by weight to about 50% by weight, about 25% by weight to about 55% by weight, about 25% by weight to about 60% by weight, about 25% by weight to about 65% by weight, about 25% by weight to about 70% by weight, about 25% by weight to about 75% by weight, about 25% by weight to about 80% by weight, about 30% by weight to about 35% by weight, about 30% by weight to about 40% by weight, about 30% by weight to about 45% by weight, about 30% by weight to about 50% by weight, about 30% by weight to about 55% by weight, about 30% by weight to about 60% by weight, about 30% by weight to about 65% by weight, about 30% by weight to about 70% by weight, about 30% by weight to about 75% by weight, about 30% by weight to about 80% by weight, about 35% by weight to about 40% by weight, about 35% by weight to about 45% by weight, about 35% by weight to about 50% by weight, about 35% by weight to about 55% by weight, about 35% by weight to about 60% by weight, about 35% by weight to about 65% by weight, about 35% by weight to about 70% by weight, about 35% by weight to about 75% by weight, about 35% by weight to about 80% by weight, about 40% by weight to about 45% by weight, about 40% by weight to about 50% by weight, about 40% by weight to about 55% by weight, about 40% by weight to about 60% by weight, about 40% by weight to about 65% by weight, about 40% by weight to about 70% by weight, about 40% by weight to about 75% by weight, about 40% by weight to about 80% by weight, about 45% by weight to about 50% by weight, about 45% by weight to about 55% by weight, about 45% by weight to about 60% by weight, about 45% by weight to about 65% by weight, about 45% by weight to about 70% by weight, about 45% by weight to about 75% by weight, about 45% by weight to about 80% by weight, about 50% by weight to about 55% by weight, about 50% by weight to about 60% by weight, about 50% by weight to about 65% by weight, about 50% by weight to about 70% by weight, about 50% by weight to about 75% by weight, about 50% by weight to about 80% by weight, about 55% by weight to about 60% by weight, about 55% by weight to about 65% by weight, about 55% by weight to about 70% by weight, about 55% by weight to about 75% by weight, about 55% by weight to about 80% by weight, about 60% by weight to about 65% by weight, about 60% by weight to about 70% by weight, about 60% by weight to about 75% by weight, about 60% by weight to about 80% by weight, about 65% by weight to about 70% by weight, about 65% by weight to about 75% by weight, about 65% by weight to about 80% by weight, about 70% by weight to about 75% by weight, about 70% by weight to about 80% by weight, or about 75% by weight to about 80% by weight. In some embodiments, the building material composition comprises lime present at a concentration of about 25% by weight, about 30% by weight, about 35% by weight, about 40% by weight, about 45% by weight, about 50% by weight, about 55% by weight, about 60% by weight, about 65% by weight, about 70% by weight, about 75% by weight, or about 80% by weight. In some embodiments, the building material composition comprises lime present at a concentration of at least about 25% by weight, about 30% by weight, about 35% by weight, about 40% by weight, about 45% by weight, about 50% by weight, about 55% by weight, about 60% by weight, about 65% by weight, about 70% by weight, or about 75% by weight. In some embodiments, the building material composition comprises lime present at a concentration of at most about 30% by weight, about 35% by weight, about 40% by weight, about 45% by weight, about 50% by weight, about 55% by weight, about 60% by weight, about 65% by weight, about 70% by weight, about 75% by weight, or about 80% by weight.

In some embodiments, the building material composition comprises pozzolan present at a concentration of about 0.5% by weight to about 75% by weight. In some embodiments, the building material composition comprises pozzolan present at a concentration of about 0.5% by weight to about 1% by weight, about 0.5% by weight to about 5% by weight, about 0.5% by weight to about 10% by weight, about 0.5% by weight to about 20% by weight, about 0.5% by weight to about 30% by weight, about 0.5% by weight to about 40% by weight, about 0.5% by weight to about 50% by weight, about 0.5% by weight to about 60% by weight, about 0.5% by weight to about 65% by weight, about 0.5% by weight to about 70% by weight, about 0.5% by weight to about 75% by weight, about 1% by weight to about 5% by weight, about 1% by weight to about 10% by weight, about 1% by weight to about 20% by weight, about 1% by weight to about 30% by weight, about 1% by weight to about 40% by weight, about 1% by weight to about 50% by weight, about 1% by weight to about 60% by weight, about 1% by weight to about 65% by weight, about 1% by weight to about 70% by weight, about 1% by weight to about 75% by weight, about 5% by weight to about 10% by weight, about 5% by weight to about 20% by weight, about 5% by weight to about 30% by weight, about 5% by weight to about 40% by weight, about 5% by weight to about 50% by weight, about 5% by weight to about 60% by weight, about 5% by weight to about 65% by weight, about 5% by weight to about 70% by weight, about 5% by weight to about 75% by weight, about 10% by weight to about 20% by weight, about 10% by weight to about 30% by weight, about 10% by weight to about 40% by weight, about 10% by weight to about 50% by weight, about 10% by weight to about 60% by weight, about 10% by weight to about 65% by weight, about 10% by weight to about 70% by weight, about 10% by weight to about 75% by weight, about 20% by weight to about 30% by weight, about 20% by weight to about 40% by weight, about 20% by weight to about 50% by weight, about 20% by weight to about 60% by weight, about 20% by weight to about 65% by weight, about 20% by weight to about 70% by weight, about 20% by weight to about 75% by weight, about 30% by weight to about 40% by weight, about 30% by weight to about 50% by weight, about 30% by weight to about 60% by weight, about 30% by weight to about 65% by weight, about 30% by weight to about 70% by weight, about 30% by weight to about 75% by weight, about 40% by weight to about 50% by weight, about 40% by weight to about 60% by weight, about 40% by weight to about 65% by weight, about 40% by weight to about 70% by weight, about 40% by weight to about 75% by weight, about 50% by weight to about 60% by weight, about 50% by weight to about 65% by weight, about 50% by weight to about 70% by weight, about 50% by weight to about 75% by weight, about 60% by weight to about 65% by weight, about 60% by weight to about 70% by weight, about 60% by weight to about 75% by weight, about 65% by weight to about 70% by weight, about 65% by weight to about 75% by weight, or about 70% by weight to about 75% by weight. In some embodiments, the building material composition comprises pozzolan present at a concentration of about 0.5% by weight, about 1% by weight, about 5% by weight, about 10% by weight, about 20% by weight, about 30% by weight, about 40% by weight, about 50% by weight, about 60% by weight, about 65% by weight, about 70% by weight, or about 75% by weight. In some embodiments, the building material composition comprises pozzolan present at a concentration of at least about 0.5% by weight, about 1% by weight, about 5% by weight, about 10% by weight, about 20% by weight, about 30% by weight, about 40% by weight, about 50% by weight, about 60% by weight, about 65% by weight, or about 70% by weight. In some embodiments, the building material composition comprises pozzolan present at a concentration of at most about 1% by weight, about 5% by weight, about 10% by weight, about 20% by weight, about 30% by weight, about 40% by weight, about 50% by weight, about 60% by weight, about 65% by weight, about 70% by weight, or about 75% by weight.

In some embodiments, the building material composition described herein further comprises filler described herein at a concentration of about 0.5% to about 25% by weight.

In some embodiments, the building material composition further comprises pozzolan present at a concentration of about 0.5% by weight to about 25% by weight. In some embodiments, the building material composition further comprises pozzolan present at a concentration of about 0.5% by weight to about 1% by weight, about 0.5% by weight to about 5% by weight, about 0.5% by weight to about 10% by weight, about 0.5% by weight to about 15% by weight, about 0.5% by weight to about 20% by weight, about 0.5% by weight to about 25% by weight, about 1% by weight to about 5% by weight, about 1% by weight to about 10% by weight, about 1% by weight to about 15% by weight, about 1% by weight to about 20% by weight, about 1% by weight to about 25% by weight, about 5% by weight to about 10% by weight, about 5% by weight to about 15% by weight, about 5% by weight to about 20% by weight, about 5% by weight to about 25% by weight, about 10% by weight to about 15% by weight, about 10% by weight to about 20% by weight, about 10% by weight to about 25% by weight, about 15% by weight to about 20% by weight, about 15% by weight to about 25% by weight, or about 20% by weight to about 25% by weight. In some embodiments, the building material composition further comprises pozzolan present at a concentration of about 0.5% by weight, about 1% by weight, about 5% by weight, about 10% by weight, about 15% by weight, about 20% by weight, or about 25% by weight. In some embodiments, the building material composition further comprises pozzolan present at a concentration of at least about 0.5% by weight, about 1% by weight, about 5% by weight, about 10% by weight, about 15% by weight, or about 20% by weight. In some embodiments, the building material composition further comprises pozzolan present at a concentration of at most about 1% by weight, about 5% by weight, about 10% by weight, about 15% by weight, about 20% by weight, or about 25% by weight.

In some embodiments, the building material composition described herein further comprises the rheology modifier described herein at a concentration of about 0.5% to about 5% by weight.

In some embodiments, the building material composition further comprises rheology modifier present at a concentration of about 0.5% by weight to about 5% by weight. In some embodiments, the building material composition further comprises rheology modifier present at a concentration of about 0.5% by weight to about 1% by weight, about 0.5% by weight to about 1.5% by weight, about 0.5% by weight to about 2% by weight, about 0.5% by weight to about 2.5% by weight, about 0.5% by weight to about 3% by weight, about 0.5% by weight to about 3.5% by weight, about 0.5% by weight to about 4% by weight, about 0.5% by weight to about 4.5% by weight, about 0.5% by weight to about 5% by weight, about 1% by weight to about 1.5% by weight, about 1% by weight to about 2% by weight, about 1% by weight to about 2.5% by weight, about 1% by weight to about 3% by weight, about 1% by weight to about 3.5% by weight, about 1% by weight to about 4% by weight, about 1% by weight to about 4.5% by weight, about 1% by weight to about 5% by weight, about 1.5% by weight to about 2% by weight, about 1.5% by weight to about 2.5% by weight, about 1.5% by weight to about 3% by weight, about 1.5% by weight to about 3.5% by weight, about 1.5% by weight to about 4% by weight, about 1.5% by weight to about 4.5% by weight, about 1.5% by weight to about 5% by weight, about 2% by weight to about 2.5% by weight, about 2% by weight to about 3% by weight, about 2% by weight to about 3.5% by weight, about 2% by weight to about 4% by weight, about 2% by weight to about 4.5% by weight, about 2% by weight to about 5% by weight, about 2.5% by weight to about 3% by weight, about 2.5% by weight to about 3.5% by weight, about 2.5% by weight to about 4% by weight, about 2.5% by weight to about 4.5% by weight, about 2.5% by weight to about 5% by weight, about 3% by weight to about 3.5% by weight, about 3% by weight to about 4% by weight, about 3% by weight to about 4.5% by weight, about 3% by weight to about 5% by weight, about 3.5% by weight to about 4% by weight, about 3.5% by weight to about 4.5% by weight, about 3.5% by weight to about 5% by weight, about 4% by weight to about 4.5% by weight, about 4% by weight to about 5% by weight, or about 4.5% by weight to about 5% by weight. In some embodiments, the building material composition further comprises rheology modifier present at a concentration of about 0.5% by weight, about 1% by weight, about 1.5% by weight, about 2% by weight, about 2.5% by weight, about 3% by weight, about 3.5% by weight, about 4% by weight, about 4.5% by weight, or about 5% by weight. In some embodiments, the building material composition further comprises rheology modifier present at a concentration of at least about 0.5% by weight, about 1% by weight, about 1.5% by weight, about 2% by weight, about 2.5% by weight, about 3% by weight, about 3.5% by weight, about 4% by weight, or about 4.5% by weight. In some embodiments, the building material composition further comprises rheology modifier present at a concentration of at most about 1% by weight, about 1.5% by weight, about 2% by weight, about 2.5% by weight, about 3% by weight, about 3.5% by weight, about 4% by weight, about 4.5% by weight, or about 5% by weight.

In some embodiments, the building material composition described herein further comprises the thickener described herein at a concentration of about 0.5% by weight to about 5% by weight.

In some embodiments, the building material composition further comprises thickener present at a concentration of about 0.5% by weight to about 5% by weight. In some embodiments, the building material composition further comprises thickener present at a concentration of about 0.5% by weight to about 1% by weight, about 0.5% by weight to about 1.5% by weight, about 0.5% by weight to about 2% by weight, about 0.5% by weight to about 2.5% by weight, about 0.5% by weight to about 3% by weight, about 0.5% by weight to about 3.5% by weight, about 0.5% by weight to about 4% by weight, about 0.5% by weight to about 4.5% by weight, about 0.5% by weight to about 5% by weight, about 1% by weight to about 1.5% by weight, about 1% by weight to about 2% by weight, about 1% by weight to about 2.5% by weight, about 1% by weight to about 3% by weight, about 1% by weight to about 3.5% by weight, about 1% by weight to about 4% by weight, about 1% by weight to about 4.5% by weight, about 1% by weight to about 5% by weight, about 1.5% by weight to about 2% by weight, about 1.5% by weight to about 2.5% by weight, about 1.5% by weight to about 3% by weight, about 1.5% by weight to about 3.5% by weight, about 1.5% by weight to about 4% by weight, about 1.5% by weight to about 4.5% by weight, about 1.5% by weight to about 5% by weight, about 2% by weight to about 2.5% by weight, about 2% by weight to about 3% by weight, about 2% by weight to about 3.5% by weight, about 2% by weight to about 4% by weight, about 2% by weight to about 4.5% by weight, about 2% by weight to about 5% by weight, about 2.5% by weight to about 3% by weight, about 2.5% by weight to about 3.5% by weight, about 2.5% by weight to about 4% by weight, about 2.5% by weight to about 4.5% by weight, about 2.5% by weight to about 5% by weight, about 3% by weight to about 3.5% by weight, about 3% by weight to about 4% by weight, about 3% by weight to about 4.5% by weight, about 3% by weight to about 5% by weight, about 3.5% by weight to about 4% by weight, about 3.5% by weight to about 4.5% by weight, about 3.5% by weight to about 5% by weight, about 4% by weight to about 4.5% by weight, about 4% by weight to about 5% by weight, or about 4.5% by weight to about 5% by weight. In some embodiments, the building material composition further comprises thickener present at a concentration of about 0.5% by weight, about 1% by weight, about 1.5% by weight, about 2% by weight, about 2.5% by weight, about 3% by weight, about 3.5% by weight, about 4% by weight, about 4.5% by weight, or about 5% by weight. In some embodiments, the building material composition further comprises thickener present at a concentration of at least about 0.5% by weight, about 1% by weight, about 1.5% by weight, about 2% by weight, about 2.5% by weight, about 3% by weight, about 3.5% by weight, about 4% by weight, or about 4.5% by weight. In some embodiments, the building material composition further comprises thickener present at a concentration of at most about 1% by weight, about 1.5% by weight, about 2% by weight, about 2.5% by weight, about 3% by weight, about 3.5% by weight, about 4% by weight, about 4.5% by weight, or about 5% by weight.

In some embodiments, the building material composition further comprises the biocide described herein at a concentration of about 0.5% to about 2% by weight.

In some embodiments, the building material composition further comprises biocide present at a concentration of about 0.5% by weight to about 2% by weight. In some embodiments, the building material composition further comprises biocide present at a concentration of about 0.5% by weight to about 1% by weight, about 0.5% by weight to about 1.5% by weight, about 0.5% by weight to about 2% by weight, about 1% by weight to about 1.5% by weight, about 1% by weight to about 2% by weight, or about 1.5% by weight to about 2% by weight. In some embodiments, the building material composition further comprises biocide present at a concentration of about 0.5% by weight, about 1% by weight, about 1.5% by weight, or about 2% by weight. In some embodiments, the building material composition further comprises biocide present at a concentration of at least about 0.5% by weight, about 1% by weight, or about 1.5% by weight. In some embodiments, the building material composition further comprises biocide present at a concentration of at most about 1% by weight, about 1.5% by weight, or about 2% by weight.

In some embodiments, the building material composition described herein further comprises the fiber described herein at a concentration of no more than about 20% by weight.

In some embodiments, the building material composition further comprises fiber present at a concentration of about 0% by weight to about 20% by weight. In some embodiments, the building material composition further comprises fiber present at a concentration of about 0% by weight to about 0.1% by weight, about 0% by weight to about 0.5% by weight, about 0% by weight to about 1% by weight, about 0% by weight to about 5% by weight, about 0% by weight to about 10% by weight, about 0% by weight to about 15% by weight, about 0% by weight to about 20% by weight, about 0.1% by weight to about 0.5% by weight, about 0.1% by weight to about 1% by weight, about 0.1% by weight to about 5% by weight, about 0.1% by weight to about 10% by weight, about 0.1% by weight to about 15% by weight, about 0.1% by weight to about 20% by weight, about 0.5% by weight to about 1% by weight, about 0.5% by weight to about 5% by weight, about 0.5% by weight to about 10% by weight, about 0.5% by weight to about 15% by weight, about 0.5% by weight to about 20% by weight, about 1% by weight to about 5% by weight, about 1% by weight to about 10% by weight, about 1% by weight to about 15% by weight, about 1% by weight to about 20% by weight, about 5% by weight to about 10% by weight, about 5% by weight to about 15% by weight, about 5% by weight to about 20% by weight, about 10% by weight to about 15% by weight, about 10% by weight to about 20% by weight, or about 15% by weight to about 20% by weight. In some embodiments, the building material composition further comprises fiber present at a concentration of about 0% by weight, about 0.1% by weight, about 0.5% by weight, about 1% by weight, about 5% by weight, about 10% by weight, about 15% by weight, or about 20% by weight. In some embodiments, the building material composition further comprises fiber present at a concentration of at least about 0% by weight, about 0.1% by weight, about 0.5% by weight, about 1% by weight, about 5% by weight, about 10% by weight, or about 15% by weight. In some embodiments, the building material composition further comprises fiber present at a concentration of at most about 0.1% by weight, about 0.5% by weight, about 1% by weight, about 5% by weight, about 10% by weight, about 15% by weight, or about 20% by weight.

In some embodiments, the building material composition described herein further comprises the earthen material described herein at a concentration of no more than about 15% by weight.

In some embodiments, the building material composition further comprises earthen material present at a concentration of about 0% by weight to about 15% by weight. In some embodiments, the building material composition further comprises earthen material present at a concentration of about 0% by weight to about 0.1% by weight, about 0% by weight to about 0.5% by weight, about 0% by weight to about 1% by weight, about 0% by weight to about 5% by weight, about 0% by weight to about 10% by weight, about 0% by weight to about 15% by weight, about 0.1% by weight to about 0.5% by weight, about 0.1% by weight to about 1% by weight, about 0.1% by weight to about 5% by weight, about 0.1% by weight to about 10% by weight, about 0.1% by weight to about 15% by weight, about 0.5% by weight to about 1% by weight, about 0.5% by weight to about 5% by weight, about 0.5% by weight to about 10% by weight, about 0.5% by weight to about 15% by weight, about 1% by weight to about 5% by weight, about 1% by weight to about 10% by weight, about 1% by weight to about 15% by weight, about 5% by weight to about 10% by weight, about 5% by weight to about 15% by weight, or about 10% by weight to about 15% by weight. In some embodiments, the building material composition further comprises earthen material present at a concentration of about 0% by weight, about 0.1% by weight, about 0.5% by weight, about 1% by weight, about 5% by weight, about 10% by weight, or about 15% by weight. In some embodiments, the building material composition further comprises earthen material present at a concentration of at least about 0% by weight, about 0.1% by weight, about 0.5% by weight, about 1% by weight, about 5% by weight, or about 10% by weight. In some embodiments, the building material composition further comprises earthen material present at a concentration of at most about 0.1% by weight, about 0.5% by weight, about 1% by weight, about 5% by weight, about 10% by weight, or about 15% by weight.

In some embodiments, the building material composition described herein further comprises the dispersant described herein at a concentration of no more than about 5% by weight.

In some embodiments, the building material composition further comprises dispersant present at a concentration of about 0% by weight to about 5% by weight. In some embodiments, the building material composition further comprises dispersant present at a concentration of about 0% by weight to about 0.1% by weight, about 0% by weight to about 0.5% by weight, about 0% by weight to about 1% by weight, about 0% by weight to about 1.5% by weight, about 0% by weight to about 2% by weight, about 0% by weight to about 2.5% by weight, about 0% by weight to about 3% by weight, about 0% by weight to about 3.5% by weight, about 0% by weight to about 4% by weight, about 0% by weight to about 4.5% by weight, about 0% by weight to about 5% by weight, about 0.1% by weight to about 0.5% by weight, about 0.1% by weight to about 1% by weight, about 0.1% by weight to about 1.5% by weight, about 0.1% by weight to about 2% by weight, about 0.1% by weight to about 2.5% by weight, about 0.1% by weight to about 3% by weight, about 0.1% by weight to about 3.5% by weight, about 0.1% by weight to about 4% by weight, about 0.1% by weight to about 4.5% by weight, about 0.1% by weight to about 5% by weight, about 0.5% by weight to about 1% by weight, about 0.5% by weight to about 1.5% by weight, about 0.5% by weight to about 2% by weight, about 0.5% by weight to about 2.5% by weight, about 0.5% by weight to about 3% by weight, about 0.5% by weight to about 3.5% by weight, about 0.5% by weight to about 4% by weight, about 0.5% by weight to about 4.5% by weight, about 0.5% by weight to about 5% by weight, about 1% by weight to about 1.5% by weight, about 1% by weight to about 2% by weight, about 1% by weight to about 2.5% by weight, about 1% by weight to about 3% by weight, about 1% by weight to about 3.5% by weight, about 1% by weight to about 4% by weight, about 1% by weight to about 4.5% by weight, about 1% by weight to about 5% by weight, about 1.5% by weight to about 2% by weight, about 1.5% by weight to about 2.5% by weight, about 1.5% by weight to about 3% by weight, about 1.5% by weight to about 3.5% by weight, about 1.5% by weight to about 4% by weight, about 1.5% by weight to about 4.5% by weight, about 1.5% by weight to about 5% by weight, about 2% by weight to about 2.5% by weight, about 2% by weight to about 3% by weight, about 2% by weight to about 3.5% by weight, about 2% by weight to about 4% by weight, about 2% by weight to about 4.5% by weight, about 2% by weight to about 5% by weight, about 2.5% by weight to about 3% by weight, about 2.5% by weight to about 3.5% by weight, about 2.5% by weight to about 4% by weight, about 2.5% by weight to about 4.5% by weight, about 2.5% by weight to about 5% by weight, about 3% by weight to about 3.5% by weight, about 3% by weight to about 4% by weight, about 3% by weight to about 4.5% by weight, about 3% by weight to about 5% by weight, about 3.5% by weight to about 4% by weight, about 3.5% by weight to about 4.5% by weight, about 3.5% by weight to about 5% by weight, about 4% by weight to about 4.5% by weight, about 4% by weight to about 5% by weight, or about 4.5% by weight to about 5% by weight. In some embodiments, the building material composition further comprises dispersant present at a concentration of about 0% by weight, about 0.1% by weight, about 0.5% by weight, about 1% by weight, about 1.5% by weight, about 2% by weight, about 2.5% by weight, about 3% by weight, about 3.5% by weight, about 4% by weight, about 4.5% by weight, or about 5% by weight. In some embodiments, the building material composition further comprises dispersant present at a concentration of at least about 0% by weight, about 0.1% by weight, about 0.5% by weight, about 1% by weight, about 1.5% by weight, about 2% by weight, about 2.5% by weight, about 3% by weight, about 3.5% by weight, about 4% by weight, or about 4.5% by weight. In some embodiments, the building material composition further comprises dispersant present at a concentration of at most about 0.1% by weight, about 0.5% by weight, about 1% by weight, about 1.5% by weight, about 2% by weight, about 2.5% by weight, about 3% by weight, about 3.5% by weight, about 4% by weight, about 4.5% by weight, or about 5% by weight.

In some embodiments, the building material composition described herein further comprises the agricultural waste described herein at a concentration of no more than about 20% by weight.

In some embodiments, the building material composition further comprises agricultural waste present at a concentration of about 0% by weight to about 20% by weight. In some embodiments, the building material composition further comprises agricultural waste present at a concentration of about 0% by weight to about 0.1% by weight, about 0% by weight to about 0.5% by weight, about 0% by weight to about 1% by weight, about 0% by weight to about 5% by weight, about 0% by weight to about 10% by weight, about 0% by weight to about 15% by weight, about 0% by weight to about 20% by weight, about 0.1% by weight to about 0.5% by weight, about 0.1% by weight to about 1% by weight, about 0.1% by weight to about 5% by weight, about 0.1% by weight to about 10% by weight, about 0.1% by weight to about 15% by weight, about 0.1% by weight to about 20% by weight, about 0.5% by weight to about 1% by weight, about 0.5% by weight to about 5% by weight, about 0.5% by weight to about 10% by weight, about 0.5% by weight to about 15% by weight, about 0.5% by weight to about 20% by weight, about 1% by weight to about 5% by weight, about 1% by weight to about 10% by weight, about 1% by weight to about 15% by weight, about 1% by weight to about 20% by weight, about 5% by weight to about 10% by weight, about 5% by weight to about 15% by weight, about 5% by weight to about 20% by weight, about 10% by weight to about 15% by weight, about 10% by weight to about 20% by weight, or about 15% by weight to about 20% by weight. In some embodiments, the building material composition further comprises agricultural waste present at a concentration of about 0% by weight, about 0.1% by weight, about 0.5% by weight, about 1% by weight, about 5% by weight, about 10% by weight, about 15% by weight, or about 20% by weight. In some embodiments, the building material composition further comprises agricultural waste present at a concentration of at least about 0% by weight, about 0.1% by weight, about 0.5% by weight, about 1% by weight, about 5% by weight, about 10% by weight, or about 15% by weight. In some embodiments, the building material composition further comprises agricultural waste present at a concentration of at most about 0.1% by weight, about 0.5% by weight, about 1% by weight, about 5% by weight, about 10% by weight, about 15% by weight, or about 20% by weight.

In some embodiments, the building material composition described herein further comprises the clay described herein at a concentration of no more than about 5% by weight.

In some embodiments, the building material composition further comprises clay present at a concentration of about 0% by weight to about 5% by weight. In some embodiments, the building material composition further comprises clay present at a concentration of about 0% by weight to about 0.1% by weight, about 0% by weight to about 0.5% by weight, about 0% by weight to about 1% by weight, about 0% by weight to about 1.5% by weight, about 0% by weight to about 2% by weight, about 0% by weight to about 2.5% by weight, about 0% by weight to about 3% by weight, about 0% by weight to about 3.5% by weight, about 0% by weight to about 4% by weight, about 0% by weight to about 4.5% by weight, about 0% by weight to about 5% by weight, about 0.1% by weight to about 0.5% by weight, about 0.1% by weight to about 1% by weight, about 0.1% by weight to about 1.5% by weight, about 0.1% by weight to about 2% by weight, about 0.1% by weight to about 2.5% by weight, about 0.1% by weight to about 3% by weight, about 0.1% by weight to about 3.5% by weight, about 0.1% by weight to about 4% by weight, about 0.1% by weight to about 4.5% by weight, about 0.1% by weight to about 5% by weight, about 0.5% by weight to about 1% by weight, about 0.5% by weight to about 1.5% by weight, about 0.5% by weight to about 2% by weight, about 0.5% by weight to about 2.5% by weight, about 0.5% by weight to about 3% by weight, about 0.5% by weight to about 3.5% by weight, about 0.5% by weight to about 4% by weight, about 0.5% by weight to about 4.5% by weight, about 0.5% by weight to about 5% by weight, about 1% by weight to about 1.5% by weight, about 1% by weight to about 2% by weight, about 1% by weight to about 2.5% by weight, about 1% by weight to about 3% by weight, about 1% by weight to about 3.5% by weight, about 1% by weight to about 4% by weight, about 1% by weight to about 4.5% by weight, about 1% by weight to about 5% by weight, about 1.5% by weight to about 2% by weight, about 1.5% by weight to about 2.5% by weight, about 1.5% by weight to about 3% by weight, about 1.5% by weight to about 3.5% by weight, about 1.5% by weight to about 4% by weight, about 1.5% by weight to about 4.5% by weight, about 1.5% by weight to about 5% by weight, about 2% by weight to about 2.5% by weight, about 2% by weight to about 3% by weight, about 2% by weight to about 3.5% by weight, about 2% by weight to about 4% by weight, about 2% by weight to about 4.5% by weight, about 2% by weight to about 5% by weight, about 2.5% by weight to about 3% by weight, about 2.5% by weight to about 3.5% by weight, about 2.5% by weight to about 4% by weight, about 2.5% by weight to about 4.5% by weight, about 2.5% by weight to about 5% by weight, about 3% by weight to about 3.5% by weight, about 3% by weight to about 4% by weight, about 3% by weight to about 4.5% by weight, about 3% by weight to about 5% by weight, about 3.5% by weight to about 4% by weight, about 3.5% by weight to about 4.5% by weight, about 3.5% by weight to about 5% by weight, about 4% by weight to about 4.5% by weight, about 4% by weight to about 5% by weight, or about 4.5% by weight to about 5% by weight. In some embodiments, the building material composition further comprises clay present at a concentration of about 0% by weight, about 0.1% by weight, about 0.5% by weight, about 1% by weight, about 1.5% by weight, about 2% by weight, about 2.5% by weight, about 3% by weight, about 3.5% by weight, about 4% by weight, about 4.5% by weight, or about 5% by weight. In some embodiments, the building material composition further comprises clay present at a concentration of at least about 0% by weight, about 0.1% by weight, about 0.5% by weight, about 1% by weight, about 1.5% by weight, about 2% by weight, about 2.5% by weight, about 3% by weight, about 3.5% by weight, about 4% by weight, or about 4.5% by weight. In some embodiments, the building material composition further comprises clay present at a concentration of at most about 0.1% by weight, about 0.5% by weight, about 1% by weight, about 1.5% by weight, about 2% by weight, about 2.5% by weight, about 3% by weight, about 3.5% by weight, about 4% by weight, about 4.5% by weight, or about 5% by weight.

In some embodiments, the building material composition described herein further comprises the clay described herein at a concentration of no more than about 25% by weight.

In some embodiments, the building material composition described herein further comprises the clay described herein at concentration of no more than about 0% by weight to about 25% by weight. In some embodiments, the building material composition described herein further comprises the clay described herein at concentration of no more than about 0% by weight to about 0.1% by weight, about 0% by weight to about 1% by weight, about 0% by weight to about 5% by weight, about 0% by weight to about 10% by weight, about 0% by weight to about 15% by weight, about 0% by weight to about 20% by weight, about 0% by weight to about 25% by weight, about 0.1% by weight to about 1% by weight, about 0.1% by weight to about 5% by weight, about 0.1% by weight to about 10% by weight, about 0.1% by weight to about 15% by weight, about 0.1% by weight to about 20% by weight, about 0.1% by weight to about 25% by weight, about 1% by weight to about 5% by weight, about 1% by weight to about 10% by weight, about 1% by weight to about 15% by weight, about 1% by weight to about 20% by weight, about 1% by weight to about 25% by weight, about 5% by weight to about 10% by weight, about 5% by weight to about 15% by weight, about 5% by weight to about 20% by weight, about 5% by weight to about 25% by weight, about 10% by weight to about 15% by weight, about 10% by weight to about 20% by weight, about 10% by weight to about 25% by weight, about 15% by weight to about 20% by weight, about 15% by weight to about 25% by weight, or about 20% by weight to about 25% by weight. In some embodiments, the building material composition described herein further comprises the clay described herein at concentration of no more than about 0% by weight, about 0.1% by weight, about 1% by weight, about 5% by weight, about 10% by weight, about 15% by weight, about 20% by weight, or about 25% by weight. In some embodiments, the building material composition described herein further comprises the clay described herein at concentration of no more than at least about 0% by weight, about 0.1% by weight, about 1% by weight, about 5% by weight, about 10% by weight, about 15% by weight, or about 20% by weight. In some embodiments, the building material composition described herein further comprises the clay described herein at concentration of no more than at most about 0.1% by weight, about 1% by weight, about 5% by weight, about 10% by weight, about 15% by weight, about 20% by weight, or about 25% by weight

In some embodiments, the building material composition described herein further comprises a combination of the magnesium oxide described herein, and the cementitious material described herein, wherein said combination is present at a concentration from about 5% to 50% by weight, the lime described herein is present at a concentration from about 40% to about 70% by weight, and the pozzolan described herein is present at a concentration from about 0.5% to about 75% by weight. In some embodiments, the building material composition described herein optionally further comprises the filler described herein at a concentration from about 0.5% to about 25% by weight. In some embodiments, the building material composition described herein optionally further comprises the fiber described herein at a concentration of no more than 20% by weight. In some embodiments, the building material composition described herein optionally further comprises the rheology modifier described herein at a concentration from about 0.5% to about 5% by weight. In some embodiments, the building material composition described herein optionally further comprises the earthen material described herein at a concentration of no more than 15% by weight. In some embodiments, the building material composition described herein optionally further comprises the thickener described herein at a concentration of about 0.5% to about 5% by weight. In some embodiments, the building material composition described herein optionally further comprises the dispersant described herein at a concentration of no more than 5%. In some embodiments, the building material composition described herein optionally further comprises the biocide described herein at a concentration of about 0.5% to about 2% by weight. In some embodiments, the building material composition described herein optionally further comprises the agricultural waste described herein at a composition of no more than 20% by weight.

In some embodiments, the building material composition further comprises a combination of magnesium oxide and cementitious material, where the combination is present at a concentration of about 5% by weight to about 50% by weight. In some embodiments, the building material composition further comprises a combination of magnesium oxide and cementitious material, where the combination is present at a concentration of about 5% by weight to about 10% by weight, about 5% by weight to about 15% by weight, about 5% by weight to about 20% by weight, about 5% by weight to about 25% by weight, about 5% by weight to about 30% by weight, about 5% by weight to about 35% by weight, about 5% by weight to about 40% by weight, about 5% by weight to about 45% by weight, about 5% by weight to about 50% by weight, about 10% by weight to about 15% by weight, about 10% by weight to about 20% by weight, about 10% by weight to about 25% by weight, about 10% by weight to about 30% by weight, about 10% by weight to about 35% by weight, about 10% by weight to about 40% by weight, about 10% by weight to about 45% by weight, about 10% by weight to about 50% by weight, about 15% by weight to about 20% by weight, about 15% by weight to about 25% by weight, about 15% by weight to about 30% by weight, about 15% by weight to about 35% by weight, about 15% by weight to about 40% by weight, about 15% by weight to about 45% by weight, about 15% by weight to about 50% by weight, about 20% by weight to about 25% by weight, about 20% by weight to about 30% by weight, about 20% by weight to about 35% by weight, about 20% by weight to about 40% by weight, about 20% by weight to about 45% by weight, about 20% by weight to about 50% by weight, about 25% by weight to about 30% by weight, about 25% by weight to about 35% by weight, about 25% by weight to about 40% by weight, about 25% by weight to about 45% by weight, about 25% by weight to about 50% by weight, about 30% by weight to about 35% by weight, about 30% by weight to about 40% by weight, about 30% by weight to about 45% by weight, about 30% by weight to about 50% by weight, about 35% by weight to about 40% by weight, about 35% by weight to about 45% by weight, about 35% by weight to about 50% by weight, about 40% by weight to about 45% by weight, about 40% by weight to about 50% by weight, or about 45% by weight to about 50% by weight. In some embodiments, the building material composition further comprises a combination of magnesium oxide and cementitious material, where the combination is present at a concentration of about 5% by weight, about 10% by weight, about 15% by weight, about 20% by weight, about 25% by weight, about 30% by weight, about 35% by weight, about 40% by weight, about 45% by weight, or about 50% by weight. In some embodiments, the building material composition further comprises a combination of magnesium oxide and cementitious material, where the combination is present at a concentration of at least about 5% by weight, about 10% by weight, about 15% by weight, about 20% by weight, about 25% by weight, about 30% by weight, about 35% by weight, about 40% by weight, or about 45% by weight. In some embodiments, the building material composition further comprises a combination of magnesium oxide and cementitious material, where the combination is present at a concentration of at most about 10% by weight, about 15% by weight, about 20% by weight, about 25% by weight, about 30% by weight, about 35% by weight, about 40% by weight, about 45% by weight, or about 50% by weight.

In some embodiments, the building material composition described herein comprises the gypsum described herein at a concentration of no more than 0.5% by weight.

In some embodiments, the building material composition described herein comprises the gypsum described herein at a concentration of no more than 0.1% by weight.

In some embodiments, the building material composition comprises gypsum present at a concentration of 0% by weight to 0.5% by weight. In some embodiments, the building material composition comprises gypsum present at a concentration of 0% by weight to 0.001% by weight, 0% by weight to 0.005% by weight, 0% by weight to 0.01% by weight, 0% by weight to 0.05% by weight, 0% by weight to 0.1% by weight, 0% by weight to 0.5% by weight, 0.001% by weight to 0.005% by weight, 0.001% by weight to 0.01% by weight, 0.001% by weight to 0.05% by weight, 0.001% by weight to 0.1% by weight, 0.001% by weight to 0.5% by weight, 0.005% by weight to 0.01% by weight, 0.005% by weight to 0.05% by weight, 0.005% by weight to 0.1% by weight, 0.005% by weight to 0.5% by weight, 0.01% by weight to 0.05% by weight, 0.01% by weight to 0.1% by weight, 0.01% by weight to 0.5% by weight, 0.05% by weight to 0.1% by weight, 0.05% by weight to 0.5% by weight, or 0.1% by weight to 0.5% by weight. In some embodiments, the building material composition comprises gypsum present at a concentration of 0% by weight, 0.001% by weight, 0.005% by weight, 0.01% by weight, 0.05% by weight, 0.1% by weight, or 0.5% by weight. In some embodiments, the building material composition comprises gypsum present at a concentration of at least 0% by weight, 0.001% by weight, 0.005% by weight, 0.01% by weight, 0.05% by weight, or 0.1% by weight. In some embodiments, the building material composition comprises gypsum present at a concentration of at most 0.001% by weight, 0.005% by weight, 0.01% by weight, 0.05% by weight, 0.1% by weight, or 0.5% by weight.

In some embodiments, the building material composition described herein comprises the crystalline silica described herein at a concentration of no more than 0.5% by weight.

In some embodiments, the building material composition described herein comprises the crystalline silica described herein at a concentration of no more than 0.1% by weight.

In some embodiments, the building material composition comprises crystalline silica present at a concentration of 0% by weight to 0.5% by weight. In some embodiments, the building material composition comprises crystalline silica present at a concentration of 0% by weight to 0.001% by weight, 0% by weight to 0.005% by weight, 0% by weight to 0.01% by weight, 0% by weight to 0.05% by weight, 0% by weight to 0.1% by weight, 0% by weight to 0.5% by weight, 0.001% by weight to 0.005% by weight, 0.001% by weight to 0.01% by weight, 0.001% by weight to 0.05% by weight, 0.001% by weight to 0.1% by weight, 0.001% by weight to 0.5% by weight, 0.005% by weight to 0.01% by weight, 0.005% by weight to 0.05% by weight, 0.005% by weight to 0.1% by weight, 0.005% by weight to 0.5% by weight, 0.01% by weight to 0.05% by weight, 0.01% by weight to 0.1% by weight, 0.01% by weight to 0.5% by weight, 0.05% by weight to 0.1% by weight, 0.05% by weight to 0.5% by weight, or 0.1% by weight to 0.5% by weight. In some embodiments, the building material composition comprises crystalline silica present at a concentration of 0% by weight, 0.001% by weight, 0.005% by weight, 0.01% by weight, 0.05% by weight, 0.1% by weight, or 0.5% by weight. In some embodiments, the building material composition comprises crystalline silica present at a concentration of at least 0% by weight, 0.001% by weight, 0.005% by weight, 0.01% by weight, 0.05% by weight, or 0.1% by weight. In some embodiments, the building material composition comprises crystalline silica present at a concentration of at most 0.001% by weight, 0.005% by weight, 0.01% by weight, 0.05% by weight, 0.1% by weight, or 0.5% by weight.

In some embodiments, the building material composition described herein further comprises water.

### Example of a Building Material Composition Suitable for Joint Compound

Provided herein is an example of a building material composition suitable for joint compound. An example nonlimiting formulation for joint compound can be found in Table 1. The building material composition suitable for joint compound, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc. For underwater operations (e.g., sea walls, offshore drilling, etc.), magnesium hydroxide is preferably used in the formulation. Thus, for all the formulations disclosed here, the ingredient of magnesium oxide can be replaced with magnesium hydroxide to provide the corresponding formulations for underwater operations.

TABLE 1
Example formulation for joint compound

| Ingredient | Percentage Range (w/w) |
|---|---|
| Magnesium oxide | About 5% to about 40% |
| Lime(s) | About 5% to about 70% |
| Cellulose ether | About 0.1% to about 10% |
| Starch ether | 0% to about 10% |
| Pozzolan | About 0.5% to about 40% |
| Glass bead(s) | About 5% to about 25% |
| Silica fume | About 1% to about 20% |
| Dispersant | About 0.1% to about 10% |
| Biocide | 0% to about 5% |
| Titanium dioxide | 0% to about 20% |

The building material composition suitable for joint compound, described herein further comprises a rheology modifier present at a concentration from about 0.1% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, or ethyl cellulose.

The building material composition suitable for joint compound, described herein further comprises a thickener or another rheology modifier present at a concentration from about 0.1% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for joint compound, described herein, further comprises a pozzolan present at a concentration from about 0.5% to about 40% by weight, wherein type GE glass-phase pozzolan, amorphous aluminosilicate, glass-phase pozzolan, rice husk ash, fly ash, vitrified calcium alumino-silicate, blast furnace slag, ground granulated blast-furnace slag, silica fume, metakaolin, volcanic tuff, calcinated diatomaceous earth, kaolinitic clays, or volcanic ash.

The building material composition suitable for joint compound, described herein, further comprises another pozzolan present at a concentration from about 0.1% to about 25% by weight, wherein the another pozzolan is silica fume, wet silica fume, dry silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

The building material composition suitable for joint compound, described herein, further comprises a filler present at a concentration from about 5% to about 25% by weight, wherein the filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for joint compound, described herein, optionally further comprises still another pozzolan present at a concentration from about 1% to about 20% by weight, wherein the still another pozzolan is fumed silica, diatomaceous earth, amorphous silica sand, natural pozzolan, volcanic ash, perlite, expanded perlite, vermiculite, kaolin, cellulose fiber, starch-based thickeners, chitin/chitosan, bentonite clay, zeolite, glass powder, fly ash, rice husk ash, natural chalk, pumice, aerogel, graphene oxide, hemp fiber fine, lignocellulosic material, metakaolin.

The building material composition suitable for joint compound, described herein, further comprises a dispersant present at a concentration from about 0.1% to about 10% by weight, wherein the dispersant is lignosulfonates, saponins, carboxymethyl starch, guar gum, or xanthan gum.

The building material composition suitable for joint compound, described herein, optionally further comprises a biocide present at concentrations from about 0.1% to about 5% by weight, wherein the biocide is citric acid, boric acid, borax, agricultural waste treated with boric acid or another biocide.

The building material composition suitable for joint compound, described herein, optionally further comprises a mineral additive present at a concentration from about 1% to about 20% by weight, wherein the mineral additive is titanium dioxide, zinc oxide, aluminum oxide, or kaolin.

### Example of a Building Material Composition Suitable for Furniture and Home Goods

Provided herein is an example of a building material composition suitable for furniture and home goods. An example nonlimiting formulation for furniture and home goods can be found in Table 2. The building material composition suitable for furniture and home goods, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc.

TABLE 2
Example formulation for furniture and home goods

| Ingredient | Percentage Range (w/w) |
|---|---|
| Magnesium oxide | About 5% to about 40% |
| Lime(s) | About 5% to about 70% |
| Chitosan | 0% to about 10% |
| Gelatinized starch | 0% to about 10% |
| Clay | 0% to about 10% |
| Pozzolan | About 0.5% to about 40% |
| Microspheres | 0% to about 25% |
| Titanium dioxide | 0% to about 20% |
| Cementitious material | 0% to about 20% |
| Expanded glass | About 5% to about 25% |
| Pigment | 0% to about 20% |
| Silica fume | About 0.1% to about 25% |

The building material composition suitable for furniture and home goods, described herein, optionally further comprises a rheology modifier at a concentration from about 0.1% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan.

The building material composition suitable for furniture and home goods, described herein, optionally further comprises a thickener or another rheology modifier at a concentration from about 0.1% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for furniture and home goods, described herein, optionally further comprises a clay present at a concentration from about 0.1% to about 10% by weight, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork.

The building material composition suitable for furniture and home goods, described herein, optionally further comprises a pozzolan present at a concentration from about 0.5% to about 40% by weight, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash.

The building material composition suitable for furniture and home goods, described herein, optionally further comprises a filler at a concentration of about 0.5% to about 25% by weight, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles.

The building material composition suitable for furniture and home goods, described herein, optionally further comprises a mineral additive present at a concentration from about 1% to about 20% by weight, wherein the mineral additive is titanium dioxide, zinc oxide, aluminum oxide, or kaolin.

The building material composition suitable for furniture and home goods, described herein, optionally further comprises a cementitious material present at a concentration of about 1% to about 20% by weight, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement.

The building material composition suitable for furniture and home goods, described herein, optionally further comprises another filler present at a concentration from about 5% to about 25% by weight, wherein the another filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for furniture and home goods, described herein, optionally further comprises pigment present at a concentration from about 1% to about 20% by weight, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment.

The building material composition suitable for furniture and home goods, described herein, optionally further comprises another pozzolan present at a concentration from about 0.1% to about 25% by weight, wherein the pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

### Example of a Building Material Composition Suitable for 3D Printing Material

Provided herein is an example of a building material composition suitable for 3D printing material. An example nonlimiting formulation for 3D printing material can be found in Table 3. The building material composition suitable for 3D printing material, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc.

TABLE 3
Example formulation for 3D printing material

| Ingredient | Percentage Range (w/w) |
|---|---|
| Magnesium oxide | About 5% to about 40% |
| Lime(s) | About 5% to about 70% |
| Carageenan | About 0.5% to about 10% |
| Agar-agar | 0% to about 10% |
| Calcinated silicate pozzolan | About 0.5% to about 10% |
| Glass bead(s) | 0% to about 20% |
| Silica fume | 0% to about 25% |
| Biocide | 0% to about 5% |
| Clay | 0% to about 25% |
| Titanium dioxide (coating) | 0% to about 1% |
| Water glass (coating) | About 0.1% to about 5% |
| Cementitious materials | 0% to about 25% |
| Pigment | 0% to about 20% |

The building material composition suitable for 3D printing material, described herein, optionally further comprises a rheology modifier at a concentration from about 0.1% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan.

The building material composition suitable for 3D printing material, described herein, optionally further comprises a thickener or another rheology modifier at a concentration from about 0.1% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for 3D printing material, described herein, optionally further comprises a filler present at a concentration from about 5% to about 25% by weight, wherein the filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for 3D printing material, described herein, optionally further comprises another filler present at a concentration from about 0.5% to about 25% by weight, wherein the another filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles.

The building material composition suitable for 3D printing material, described herein, optionally further comprises another pozzolan present at a concentration from about 0.1% to about 25% by weight, wherein, the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

The building material composition suitable for 3D printing material, described herein, optionally further comprises a biocide present at a concentration from about 0.1% to about 5% by weight, wherein the biocide is citric acid, boric acid, borax, agricultural waste treated with boric acid or another biocide.

The building material composition suitable for 3D printing material, described herein, optionally further comprises a clay present at a concentration from about 0.1% to about 5% by weight, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork.

The building material composition suitable for 3D printing material, described herein, optionally further comprises a coating, wherein the coating is water glass, mineral coating, or breathable coating.

The building material composition suitable for 3D printing material, described herein, optionally further comprises another coating, wherein the another coating is titanium dioxide, zinc oxide, aluminum oxide, or kaolin.

The building material composition suitable for 3D printing material, described herein, optionally further comprises a cementitious material present at a concentration from about 1% to about 20% by weight, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement.

The building material composition suitable for 3D printing material, described herein, optionally further comprises a pigment at a concentration from about 1% to about 20% by weight, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment.

### Example of a Building Material Composition Suitable for a Wall Panel

Provided herein is an example of a building material composition suitable for a wall panel. An example nonlimiting formulation for wall panel can be found in Table 4. The building material composition suitable for a wall panel, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc.

TABLE 4
Example formulation for 3D printing material

| Ingredient | Percentage Range (w/w) |
|---|---|
| Magnesium oxide | About 5% to about 40% |
| Lime(s) | About 5% to about 70% |
| Crosslinked cellulose ether | 0% to about 10% |
| Potato starch | 0% to about 10% |
| Mesh | 0% to about 25% |
| Fiber | About 1% to about 70% |
| Pozzolan | 0% to about 25% |
| Glass bead(s) | 0% to about 5% |
| Pigment | 0% to about 20% |
| Clay | 0% to about 25% |
| Silica fume | 0% to about 20% |
| Cementitious materials | About 5% to about 70% |

The building material composition suitable for a wall panel, described herein, optionally further comprises a rheology modifier present at a concentration from about 0.5% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan.

The building material composition suitable for a wall panel, described herein, optionally further comprises a thickener or another rheology modifier present at a concentration from about 0.5% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for a wall panel, described herein, optionally further comprises a netting present at a composition from about 0.5% to about 25% by weight, wherein the netting is mesh, jute, coconut coir, hemp, geotextiles, or wool matting.

The building material composition suitable for a wall panel, described herein, optionally further comprises a fiber present at a concentration from about 0.5% to about 25% by weight, wherein the fiber is flax, hemp, cotton, coconut fiber, coconut coir, bamboo, bagasse, rice husk, or straw.

The building material composition suitable for a wall panel, described herein, optionally further comprises a pozzolan present at a concentration from about 1% to about 70% by weight, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash.

The building material composition suitable for a wall panel, described herein, optionally further comprises a filler present at a concentration from about 1% to about 70% by weight, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles.

The building material composition suitable for a wall panel, described herein, optionally further comprises another filler present at a concentration from about 5% top about 25% by weight, wherein the another filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for a wall panel, described herein, optionally further comprises a pigment present at a concentration from about 1% to about 20% by weight, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment.

The building material composition suitable for a wall panel, described herein, optionally further comprises a clay present at a concentration from about 0.1% to about 25% by weight, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork.

The building material composition suitable for a wall panel, described herein, optionally further comprises another pozzolan present at a concentration from about 1% to about 20% by weight, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

The building material composition suitable for a wall panel, described herein, optionally further comprises a cementitious material present at a concentration from about 5% to about 70% by weight, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement.

### Example of a Building Material Composition Suitable for Floor and Wall Tile

Provided herein is an example of a building material composition suitable for floor and wall tile. An example nonlimiting formulation for floor and wall tile can be found in Table 5. The building material composition suitable for floor and wall tile, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc.

TABLE 5
Example formulation for floor and wall tiles

| Ingredient | Percentage Range (w/w) |
|---|---|
| Magnesium oxide | About 5% to about 40% |
| Lime(s) | About 5% to about 70% |
| Guar Gum | 0% to about 10% |
| Starch ether | 0% to about 10% |
| Clay | 0% to about 10% |
| Pozzolan | About 5% to about 70% |
| Glass bead(s) | 0% to about 20% |
| Cementitious materials | About 5% to about 70% |
| Pectin | 0% to about 20% |

The building material composition suitable for floor and wall tile, described herein, optionally further comprises a rheology modifier present at a concentration from about 0.1% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan.

The building material composition suitable for floor and wall tile, described herein, optionally further comprises a thickener or another rheology modifier present at a concentration from about 0.1% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for floor and wall tile, described herein, optionally further comprises a clay present at a concentration from about 0.1% to about 10% by weight, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork.

The building material composition suitable for floor and wall tile, described herein, optionally further comprises a pozzolan present at a concentration from about 5% to about 75% by weight, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash.

The building material composition suitable for floor and wall tile, described herein, optionally further comprises a filler present at a concentration from about 5% to about 25% by weight, wherein the filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for floor and wall tile, described herein, optionally further comprises another filler present at a concentration from about 0.5% to about 25% by weight, wherein the another filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles.

The building material composition suitable for floor and wall tile, described herein, optionally further comprises a cementitious material present at a concentration from about 1% to about 25% by weight, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement.

The building material composition suitable for floor and wall tile, described herein, optionally further comprises another pozzolan present at a concentration from about 0.1% to about 25% by weight, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

### Example of a Building Material Composition Suitable for an Acoustical Panel

Provided herein is an example of a building material composition suitable for an acoustical panel. An example nonlimiting formulation of acoustical panel can be found in Table 6. The building material composition suitable for an acoustical panel, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc.

TABLE 6
Example formulation for acoustical panel

| Ingredient | Percentage Range (w/w) |
|---|---|
| Magnesium oxide | About 5% to about 40% |
| Lime(s) | About 5% to about 70% |
| Polymers | 0% to about 10% |
| Tapioca starch | 0% to about 10% |
| Mesh | 0% to about 25% |
| Fiber | About 1% to about 25% |
| Pozzolan | About 1% to about 70% |
| Microspheres | About 1% to about 25% |
| Glass bead(s) | About 1% to about 25% |
| Pigment | 0% to about 20% |
| Cementitious materials | About 5% to about 70% |
| Rice husk ash | 0% to about 20% |

The building material composition suitable for an acoustical panel, described herein, optionally further comprises a rheology modifier present at a concentration from about 0.1% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan.

The building material composition suitable for an acoustical panel, described herein, optionally further comprises a thickener or another rheology modifier present at a concentration from about 0.1% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for an acoustical panel, described herein, optionally further comprises a netting present at a concentration from about 1% to about 25% by weight, wherein the netting is mesh, jute, coconut coir, hemp, geotextiles, or wool matting, preferably mesh.

The building material composition suitable for an acoustical panel, described herein, optionally further comprises a fiber present at a concentration from about 1% to about 5% by weight, wherein the fiber is flax, hemp, cotton, coconut fiber, coconut coir, bamboo, bagasse, rice husk, or straw.

The building material composition suitable for an acoustical panel, described herein, optionally further comprises a pozzolan present at a concentration from about 1% to about 75% by weight, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash.

The building material composition suitable for an acoustical panel, described herein, optionally further comprises a filler present at a concentration from about 5% to about 25% by weight, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles.

The building material composition suitable for an acoustical panel, described herein, optionally further comprises another filler present at a concentration from about 5% to about 25% by weight, wherein the another filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for an acoustical panel, described herein, optionally further comprises a pigment present at a concentration from about 1% to about 20% by weight, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment.

The building material composition suitable for an acoustical panel, described herein, optionally further comprises a cementitious material present at a concentration from about 1% to about 25% by weight, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement.

The building material composition suitable for an acoustical panel, described herein, optionally further comprises another pozzolan present at a concentration from about 0.1% to about 25% by weight, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

### Example of a Building Material Composition Suitable for Pigmented Compound or Plaster

Provided herein is an example of a building material composition suitable for pigmented compound or plaster. An example nonlimiting formulation of pigmented compound or plaster can be found in Table 7. The building material composition suitable for pigmented compound or plaster, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc. For underwater operations (e.g., sea walls, offshore drilling, etc.), magnesium hydroxide is preferably used in the formulation. Thus, for all the formulations disclosed here, the ingredient of magnesium oxide can be replaced with magnesium hydroxide to provide the corresponding formulations for underwater operations.

TABLE 7
Example formulation for pigmented compound or plaster

| Ingredient | Percentage Range (w/w) |
|---|---|
| Magnesium oxide | About 5% to about 40% |
| Lime(s) | About 5% to about 70% |
| Anionic cellulose ether | About 0.1% to about 10% |
| Carob gum | About 0.1% to about 10% |
| Volcanic ash | About 1% to about 25% |
| Glass bead(s) | 0% to about 10% |
| Fly ash | About 1% to about 10% |
| Dispersant | About 0.1% to about 10% |
| Biocide | 0% to about 5% |
| Titanium dioxide | About 1% to about 20% |
| Pigment | About 1% to about 20% |
| Paint (coating) | 0% to about 2% |

The building material composition suitable for pigmented compound or plaster, described herein, further comprises a rheology modifier present at a concentration from about 0.1% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan.

The building material composition suitable for pigmented compound or plaster, described herein, further comprises a thickener or another rheology modifier present at a concentration from about 0.1% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for pigmented compound or plaster, described herein, further comprises a pozzolan present at a concentration from about 1% to about 25% by weight, wherein the pozzolan is vitrified calcium alumino-silicate, rice husk ash, fly ash, blast furnace slag, ground granulated blast-furnace slag, silica fume, metakaolin, volcanic tuff, calcinated diatomaceous earth, kaolinitic clays, or volcanic ash.

The building material composition suitable for pigmented compound or plaster, described herein, optionally further comprises a filler present at a concentration from about 1% to about 10% by weight, wherein the filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for pigmented compound or plaster, described herein, optionally further comprises another filler present at a concentration from about 1% to about 10% by weight, wherein the another filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles.

The building material composition suitable for pigmented compound or plaster, described herein, further comprises another pozzolan present at a concentration from about 0.1% to about 25% by weight, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

The building material composition suitable for pigmented compound or plaster, described herein, further comprises a dispersant present at a concentration from about 0.1% to about 10% by weight, wherein the dispersant is lignosulfonates, saponins, carboxymethyl starch, guar gum, or xanthan gum.

The building material composition suitable for pigmented compound or plaster, described herein, optionally further comprises a biocide present at a concentration from about 0.1% to about 5% by weight, wherein the biocide is citric acid, boric acid, borax, agricultural waste treated with boric acid or another biocide.

The building material composition suitable for pigmented compound or plaster, described herein, further comprises a mineral additive present at a concentration from about 1% to about 20% by weight, wherein the mineral additive is titanium dioxide, zinc oxide, aluminum oxide, or kaolin.

The building material composition suitable for pigmented compound or plaster, described herein, further comprises a pigment present at a concentration from about 1% to about 20% by weight, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment.

The building material composition suitable for pigmented compound or plaster, described herein, optionally further comprises a paint wherein the paint is mineral coating, silicate paint, natural casein paint, or natural cement paint.

### Example of a Building Material Composition Suitable for Cast Architectural Products

Provided herein is an example of a building material composition suitable for cast architectural products. An example nonlimiting formulation for cast architectural product can be found in Table 8. The building material composition suitable for cast architectural products, described herein, comprises the magnesium oxide or magnesium hydroxide as described herein, present at a concentration from about 5% to about 40% by weight, the lime material described herein at a concentration from about 5% to about 70% by weight, wherein the lime material comprises a first lime, and the first lime is independently calcinated lime, hydrated lime, high calcium hydrated lime, hydraulic lime, lime putty, quicklime, fat lime, calcium carbonate, earthen lime plaster, magnesium hydroxide, or calcium hydroxide. In some embodiments, the lime material further comprises a second lime, and the second lime is independently calcinated lime, hydrated lime, high calcium hydrated lime, hydraulic lime, lime putty, quicklime, fat lime, calcium carbonate, earthen lime plaster, magnesium hydroxide, or calcium hydroxide, and wherein the first lime is different from the second lime. For example, in some embodiments, the first lime is calcinated lime, and the second lime is high calcium hydrated lime or another lime that is not calcinated lime; the first lime is hydraulic lime, and the second lime is lime putty or another lime that is not hydraulic lime; the first lime is quick lime, and the second lime is quicklime or another lime that is not quicklime, etc. For underwater operations (e.g., sea walls, offshore drilling, etc.), magnesium hydroxide is preferably used in the formulation. Thus, for all the formulations disclosed here, the ingredient of magnesium oxide can be replaced with magnesium hydroxide to provide the corresponding formulations for underwater operations.

TABLE 8
Example formulation for cast architectural product

| Ingredient | Percentage Range (w/w) |
|---|---|
| Magnesium oxide | About 5% to about 40% |
| Lime(s) | About 5% to about 70% |
| Carboxymethyl cellulose | 0% to about 10% |
| Modified starch | 0% to about 10% |
| Clay | 0% to about 10% |
| Microspheres | 0% to about 25% |
| Pozzolan | About 1% to about 70% |
| Glass bead(s) | 0% to about 30% |
| Cementitious materials | 0% to about 25% |
| Pigment | 0% to about 20% |
| Titanium dioxide | About 1% to about 20% |
| Dispersant | 0% to about 10% |
| Biocide | 0% to about 20% |
| Metakaolin | 0% to about 20% |

The building material composition suitable for cast architectural products, described herein, optionally further comprises a rheology modifier present at a concentration from about 0.1% to about 10% by weight, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan.

The building material composition suitable for cast architectural products, described herein, optionally further comprises a thickener or another rheology modifier present at a concentration from about 0.1% to about 10% by weight, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract.

The building material composition suitable for cast architectural products, described herein, optionally further comprises a clay present at a concentration from about 0.1% to about 10% by weight, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork.

The building material composition suitable for cast architectural products, described herein, optionally further comprises a filler present at a concentration from about 1% to about 25% by weight, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles.

The building material composition suitable for cast architectural products, described herein, further comprises a pozzolan present at a concentration from about 1% to about 70% by weight, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash.

The building material composition suitable for cast architectural products, described herein, optionally further comprises another filler present at a concentration from about 2% to about 30% by weight, wherein the another filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice.

The building material composition suitable for cast architectural products, described herein, optionally further comprises a cementitious material present at a concentration from about 1% to about 25% by weight, wherein the cementitious material is geopolymer, ground granulated blast-furnace slag, rice husk ash, adobe, cob, metakaolin, calcium sulfoaluminate, calcium aluminate cement, aluminum oxide, nepheline syenite, kaolin, or bio-cement.

The building material composition suitable for cast architectural products, described herein, optionally further comprises a pigment present at a composition from about 0.5% to about 20% by weight, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment.

The building material composition suitable for cast architectural products, described herein, further comprises a mineral additive present at a concentration from about 1% to about 20% by weight, wherein the mineral additive is titanium dioxide, zinc oxide, aluminum oxide, or kaolin.

The building material composition suitable for cast architectural products, described herein, optionally further comprises a dispersant present at a concentration from about 0.1% to about 10% by weight, wherein the dispersant is lignosulfonates, saponins, carboxymethyl starch, guar gum, or xanthan gum.

The building material composition suitable for cast architectural products, described herein, optionally further comprises a biocide present at a concentration from about 0.1% to about 10% by weight, wherein the biocide is citric acid, boric acid, borax, agricultural waste treated with boric acid or another biocide.

The building material composition suitable for cast architectural products, described herein, optionally further comprises another pozzolan present at a composition from about 1% to about 20% by weight, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan.

### Example of Tests on Selected Building Material

Products made from the disclosed composition can be tested for various properties as needed. An example nonlimiting formulation for drywall topping can be found in Table 9.

TABLE 9
Example formulation for drywall topping

| Ingredient | Percentage Range (w/w) |
|---|---|
| Magnesium oxide | About 5% to about 15% |
| Lime(s) | About 30% to about 50% |
| Glass beads | About 10% to about 20% |
| Pozzolan | About 10% to about 15% |
| Cellulose ether | About 0.1% to about 4% |
| Starch ether | About 0.1% to about 4% |
| Silica fume | About 0.1% to about 4% |
| Dispersant | About 0.1% to about 4% |
| Biocide | About 0.1% to about 4% |
| Titanium dioxide | About 2% to about 15% |
| Microspheres | 0% to about 10% |

It can be understood that the skilled artisan can adjust the relative amounts of the disclosed ingredients in Table 9 as needed, and test the resulting drywall topping to the specific task at work, then adjust the relative amounts of selected ingredients to achieve the desired results. Such tests include, but are not limited to: total dry time, bulk density of the dried product, consistency, uniformity (e.g., level of viscosity, even flow/easy spread or not, stickiness, etc.), average thickness after drying, adhesion, sagging dry wall or not, moisture test (days/weeks), cracking or not (days/weeks), sands to level 5 or not, durability test, drop ball test, finish (smoothness, or bubbles and chunks), etc. It is noted that, in the absence of added gypsum, the drywall toppings according to the formulation in Table 9 work as well as those with added gypsum. It is also noted no crystalline silica is detected in the drywall toppings according to the formulation in Table 9.

### Example Calculations of Possible CO₂ Removal

Inputting general conditions like average levels of humidity, temperature. For UV conversions, 13 hours of light was estimated (including electrical and daylight), average and low light intensity. Surfaces are assumed to have a 2 mm thickness.

Estimated sequestration per square foot: Ingredient 1 is lime material: 642.4 g CO₂ per square foot over 5 years. Ingredient 2 is magnesium oxide: 1452.4 g CO₂ per square foot over 3 years. Ingredient 3 is titanium dioxide: 156.2 g CO₂ per square foot over the lifetime of the wall.

Assuming a 1250 sq ft house having 3 bedrooms, 2 bathrooms, average closets and hallways, with 8′ ceilings: Total wall space: 2648 sq ft. Total wall and ceiling space: 3898 sq ft, 2 mm thick. Total estimated sequestration for 1250 square foot house over 5 years is 14,976.25 kg of CO₂, an average of 2995.25 kg CO₂ per year. This offsets the emissions of approximately 0.65 cars over the first year, and 3.26 cars over the first five years. Please note that the above are estimated numbers only.

Total estimated sequestration for a 2500 square foot house (7,796 sq ft interior surface) over 5 years is 29,952 kg CO₂, an average of 5990.5 kg CO₂ per year. This offsets the emissions of approximately 1.3 cars over the first year, and 6.51 cars over the first five years. Please note that the above are estimated numbers only.

Approximately 1.4 million houses were constructed in 2023. The total sequestration for 1.4 million 2500 square foot houses is 8.39 metric tons of CO₂ per year over the first 5 years. This is equivalent to the annual emissions of 1.8 million cars. This is equivalent to the sequestration of 138 million tree seedlings grown for 10 years. This is equivalent to the annual energy-related emissions of 1 million U.S. homes. This is equivalent to the emissions of 1.2 million transatlantic flights. Please note that the above are estimated numbers only.

While preferred embodiments of the present application have been shown and described herein, it will be obvious to those skilled in the art that such embodiments are provided by way of example only. Numerous variations, changes, and substitutions will now occur to those skilled in the art without departing from the methods and systems described herein. It should be understood that various alternatives to the embodiments of the methods and systems described herein may be employed in practicing said methods and systems. It is intended that the following claims define the scope of the application and that methods and systems within the scope of these claims and their equivalents be covered thereby.

1. A building material composition that absorbs carbon dioxide during use, comprising:
magnesium oxide or magnesium hydroxide, preferably magnesium oxide;
a lime material comprising a calcium oxide and/or a calcium hydroxide; and
a pozzolan,
wherein the building material composition comprises gypsum at a concentration no more than 1.5% by weight of the building material composition.

2. The building material of claim 1, further comprising at least one material selected from the group consisting of: filler, titanium dioxide, earthen material, rheology modifier, thickener, cementitious material, fiber, netting, clay, biocide, and dispersant.

3. The building material of claim 2, wherein the lime material is type N lime, type S lime, calcinated lime, hydrated lime, magnesium hydroxide, high calcium hydrated lime, hydraulic lime, lime putty, quick lime, fat lime, earthen lime plaster, or slaked lime, or a combination thereof.

4. The building material of claim 3, wherein the lime material comprises natural hydraulic lime.

5.-18. (canceled)

19. The building material of claim 2, further comprising the clay, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork, or a combination thereof, wherein the crete is papercrete or hempcrete.

20.-21. (canceled)

22. The building material of claim 1, further comprising a pigment or a dye,
wherein the pigment or the dye is iron oxides, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment,
wherein the ultramarine is natural ultramarine or synthetic ultramarine,
wherein the charcoal is burnt wood or plant-based charcoal, and
wherein the biological pigment is algae-derived pigment or bacteria-derived pigment.

23. (canceled)

24. The building material composition of claim 1, wherein:
magnesium oxide is present at a concentration from about 0.5% to about 50%;
the lime material is present at a concentration from about 25% to about 80%; and
the pozzolan is present at a concentration from about 0.5% to about 75%,
wherein all percentages are by weight of the building material composition.

25.-34. (canceled)

35. The building material composition of claim 1, wherein the building material composition comprises gypsum at a concentration no more than 0.5% by weight of the building material composition.

36. The building material composition of claim 35, wherein the building material composition comprises gypsum at a concentration no more than 0.1% by weight of the building material composition.

37. The building material composition of claim 1, wherein the building material composition comprises crystalline silica at a concentration no more than 0.5% by weight of the building material composition.

38. The building material composition of claim 37, wherein the building material composition comprises crystalline silica at a concentration no more than 0.1% by weight of the building material composition.

39. The building material composition of claim 1, further comprising water.

40. The building material composition of claim 39, wherein:
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
the rheology modifier is present at a concentration from about 0.1% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, or ethyl cellulose, preferably cellulose ether;
the thickener or another rheology modifier is present at a concentration from about 0.1% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
the pozzolan is present at a concentration from about 0.5% to about 40%, wherein the pozzolan is type GE glass-phase pozzolan, amorphous aluminosilicate, glass-phase pozzolan, rice husk ash, fly ash, vitrified calcium alumino-silicate, blast furnace slag, ground granulated blast-furnace slag, silica fume, metakaolin, volcanic tuff, calcinated diatomaceous earth, kaolinitic clays, or volcanic ash, preferably type GE glass pozzolan;
another pozzolan is present at a concentration from about 0.1% to about 25%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume;
the filler is present at a concentration from about 5% to about 25%, wherein the filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably expanded glass beads;
optionally still another pozzolan is present at a concentration from about 1% to about 20%, wherein the still another pozzolan is fumed silica, diatomaceous earth, amorphous silica sand, natural pozzolan, volcanic ash, perlite, expanded perlite, vermiculite, kaolin, cellulose fiber, starch-based thickeners, chitin/chitosan, bentonite clay, zeolite, glass powder, fly ash, rice husk ash, natural chalk, pumice, aerogel, graphene oxide, hemp fiber fine, lignocellulosic material, metakaolin, preferably fumed silica;
the dispersant is present at a concentration from about 0.1% to about 10%, wherein the dispersant is lignosulfonates, saponins, carboxymethyl starch, guar gum, or xanthan gum;
optionally the biocide is present at a concentration from about 0.1% to about 5%, wherein the biocide is citric acid, boric acid, borax, agricultural waste treated with boric acid or another biocide; and
optionally a mineral additive is present at a concentration from about 1% to about 20%, wherein the mineral additive is titanium dioxide, zinc oxide, aluminum oxide, or kaolin, preferably titanium dioxide,
wherein all percentages are by weight of the building material composition.

41. The building material composition of claim 39, wherein:
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
optionally the rheology modifier is present at a concentration from about 0.1% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan, preferably cellulose ether;
optionally the thickener or another rheology modifier is present at a concentration from about 0.1% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
optionally the clay is present at a concentration from about 0.1% to about 10%, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork;
the pozzolan is present at a concentration from about 0.5% to about 40%, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash;
optionally the filler is present at a concentration from about 0.5% to about 25%, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles, preferably microsphere;
optionally a mineral additive is present at a concentration from about 1% to about 20%, wherein the mineral additive is titanium dioxide, zinc oxide, aluminum oxide, or kaolin, preferably titanium dioxide;
optionally the cementitious material is present at a concentration from about 1% to about 20%, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement;
another filler is present at a concentration from about 5% to about 25%, wherein the another filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably expanded glass beads;
optionally the pigment is present at a concentration from about 1% to about 20%, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment; and
optionally another pozzolan is present at a concentration from about 0.1% to about 25%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume,
wherein all percentages are by weight of the building material composition.

42. The building material composition of claim 39, wherein:
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
optionally the rheology modifier is present at a concentration from about 0.1% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan, preferably cellulose ether;
optionally the thickener or another rheology modifier is present at a concentration from about 0.1% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
the pozzolan is present at a concentration from about 0.5% to about 75%, wherein the pozzolan is calcinated silicate, rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash, preferably calcinated silicate;
optionally the filler is present at a concentration from about 5% to about 25%, wherein the filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably expanded glass beads;
optionally another filler is present at a concentration from about 0.5% to about 25%, wherein the another filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles, preferably microsphere;
optionally another pozzolan is present at a concentration from about 0.1% to about 25%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume,
optionally the biocide is present at a concentration from about 0.1% to about 5%, wherein the biocide is citric acid, boric acid, borax, agricultural waste treated with boric acid or another biocide;
optionally the clay is present at a concentration from about 0.1% to about 25%, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork;
optionally a coating is present, wherein the coating is water glass, mineral coating, or breathable coating, preferably water glass;
optionally another coating is present, wherein the another coating is titanium dioxide, zinc oxide, aluminum oxide, or kaolin, preferably titanium dioxide;
optionally the cementitious material is present at a concentration from about 1% to about 25%, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement; and
optionally the pigment is present at a concentration from about 1% to about 20%, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment;
wherein all percentages are by weight of the building material composition.

43. The building material composition of claim 39, wherein:
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
optionally the rheology modifier is present at a concentration from about 0.5% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan, preferably cellulose ether;
optionally the thickener or another rheology modifier is present at a concentration from about 0.5% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
optionally the netting is present at a concentration from about 0.5% to about 25%, wherein the netting is mesh, jute, coconut coir, hemp, geotextiles, or wool matting, preferably mesh;
optionally the fiber is present at a concentration from about 0.5% to about 25%, wherein the fiber is flax, hemp, cotton, coconut fiber, coconut coir, bamboo, bagasse, rice husk, or straw;
the pozzolan is present at a concentration from about 1% to about 70%, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash;
optionally the filler is present at a concentration from about 0.5% to about 25%, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles, preferably microsphere;
optionally another filler is present at a concentration from about 5% to about 25%, wherein the another filler is expanded glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably expanded glass beads;
optionally the pigment is present at a concentration from about 1% to about 20%, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment;
optionally the clay is present at a concentration from about 0.1% to about 25%, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork;
optionally another pozzolan is present at a concentration from about 1% to about 20%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume; and
the cementitious material is present at a concentration from about 5% to about 70%, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement;
wherein all percentages are by weight of the building material composition.

44. The building material composition of claim 39, wherein:
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
optionally the rheology modifier is present at a concentration from about 0.1% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan, preferably cellulose ether;
optionally the thickener or another rheology modifier is present at a concentration from about 0.1% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
optionally the clay is present at a concentration from about 0.1% to about 10%, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork;
the pozzolan is present at a concentration from about 5% to about 75%, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash;
optionally the filler is present at a concentration from about 5% to about 25%, wherein the filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably glass beads;
optionally another filler is present at a concentration from about 0.5% to about 25%, wherein the another filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles, preferably microsphere;
the cementitious material is present at a concentration from about 1% to about 25%, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement; and
optionally another pozzolan is present at a concentration from about 0.1% to about 25%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume,
wherein all percentages are by weight of the building material composition.

45. The building material composition of claim 39,
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
optionally the rheology modifier is present at a concentration from about 0.1% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan, preferably cellulose ether;
optionally the thickener or another rheology modifier is present at a concentration from about 0.1% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
the netting is present at a concentration from about 1% to about 25%, wherein the netting is mesh, jute, coconut coir, hemp, geotextiles, or wool matting, preferably mesh;
optionally the fiber is present at a concentration from about 1% to about 25%, wherein the fiber is flax, hemp, cotton, coconut fiber, coconut coir, bamboo, bagasse, rice husk, or straw;
the pozzolan is present at a concentration from about 1% to about 75%, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash;
the filler is present at a concentration from about 0.5% to about 25%, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles, preferably microsphere;
another filler is present at a concentration from about 5% to about 25%, wherein the another filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably glass beads;
optionally the pigment is present at a concentration from about 1% to about 20%, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment;
the cementitious material is present at a concentration from about 1% to about 25%, wherein the cementitious material is fly ash, geopolymer, ground granulated blast-furnace slag, rice husk ash, adobe, cob, metakaolin, calcium sulfoaluminate, calcium aluminate cement, aluminum oxide, nepheline syenite, kaolin, or bio-cement; and
optionally another pozzolan is present at a concentration from about 0.1% to about 25%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume,
wherein all percentages are by weight of the building material composition.

46. The building material composition of claim 39,
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
the rheology modifier is present at a concentration from about 0.1% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan, preferably cellulose ether;
the thickener or another rheology modifier is present at a concentration from about 0.1% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
the pozzolan is present at a concentration from about 1% to about 25%, wherein the pozzolan is vitrified calcium alumino-silicate, rice husk ash, fly ash, blast furnace slag, ground granulated blast-furnace slag, silica fume, metakaolin, volcanic tuff, calcinated diatomaceous earth, kaolinitic clays, or volcanic ash, preferably vitrified calcium alumino-silicate;
optionally the filler is present at a concentration from about 1% to about 10%, wherein the filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably glass beads;
optionally another filler is present at a concentration from about 1% to about 10%, wherein the another filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles, preferably microsphere;
another pozzolan is present at a concentration from about 0.1% to about 25%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume;
the dispersant is present at a concentration from about 0.1% to about 10%, wherein the dispersant is lignosulfonates, saponins, carboxymethyl starch, guar gum, or xanthan gum;
optionally the biocide is present at a concentration from about 0.1% to about 5%, wherein the biocide is citric acid, boric acid, borax, agricultural waste treated with boric acid or another biocide;
a mineral additive is present at a concentration from about 1% to about 20%, wherein the mineral additive is titanium dioxide, zinc oxide, aluminum oxide, or kaolin, preferably titanium dioxide;
the pigment is present at a concentration from about 1% to about 20%, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment; and
optionally a paint, wherein the paint is mineral coating, silicate paint, natural casein paint, or natural cement paint,
wherein all percentages are by weight of the building material composition.

47. The building material composition of claim 39, wherein:
magnesium oxide is present at a concentration from about 5% to about 40%;
the lime material is present at a concentration from about 5% to about 70% and comprises a first lime and a second lime;
wherein each of the first lime and the second lime is independently calcinated lime, hydrated lime, magnesium hydroxide, high calcium hydrated lime, hydraulic lime, lime putty, quicklime, fat lime, calcium carbonate, earthen lime plaster, or calcium hydroxide;
optionally the rheology modifier is present at a concentration from about 0.1% to about 10%, wherein the rheology modifier is cellulose ether, hydroxypropyl methyl cellulose, methyl cellulose, hydroxyethyl cellulose, hydroxypropyl cellulose, modified hydroxyethyl cellulose, hydroxyethyl methylcellulose, methyl hydroxyethyl cellulose, anionic cellulose ether, nonionic cellulose ether, crosslinked cellulose ether, hydrophobically modified cellulose ether, low-viscosity cellulose ether, high-viscosity cellulose ether, ethyl cellulose, carrageenan, tragacanth gum, native starch, or chitosan, preferably cellulose ether;
optionally the thickener or another rheology modifier is present at a concentration from about 0.1% to about 10%, wherein the thickener or the another rheology modifier is starch ether, gelatinized starch, cellulose based starch, modified starch, carboxymethyl cellulose, guar gum, xanthan gum, pectin, carob gum, hydrolyzed polyvinyl alcohol, bio polymer, gum acacia, tara gum, bentonite clay, alginate, agar-agar, non-etherified starch agent variant, or rice bran extract, preferably starch ether;
optionally the clay is present at a concentration from about 0.1% to about 10%, wherein the clay is kaolinite, cob, adobe, straw/hemp/fibrous plaster, amorphous geopolymer clay, rammed earth, crete, mycelium, wood fiber based clays, sandstone, ash, reclaimed soil, crushed dust including brick and stone, aggregates, recycled cellulose, cork, or expanded cork;
optionally the filler is present at a concentration from about 1% to about 25%, wherein the filler is microsphere, fly ash cenospheres, diatomite, rice husk ash, foamed amorphous silica, natural pumice microspheres, non-toxic zeolite micronized foam, nanocellulose, microfibrillated cellulose, biochar microspheres, calcium carbonate microspheres, perlite microspheres, volcanic tuff nanoparticles, or microbubbles, preferably microsphere;
the pozzolan is present at a concentration from about 1% to about 70%, wherein the pozzolan is rice husk ash, fly ash, glass-phase pozzolan, amorphous aluminosilicate, vitrified calcium alumino-silicate, blast furnace slag, ground granulated blast-furnace slag, silica fume, metakaolin, volcanic tuff, calcinated diatomaceous earth, kaolinitic clays, or volcanic ash;
optionally another filler is present at a concentration from about 2% to about 30%, wherein the another filler is glass beads, foam beads, ceramic beads, glass bubbles, beads, perlite, expanded clay, coarse vermiculite, granular non-toxic zeolite, tuff, cork, wood pellets, wood fibers, rice husk granules, biochar pellets, crushed shells, coarse calcium carbonate, natural gravel, natural sand, or coarse pumice, preferably glass beads;
optionally the cementitious material is present at a concentration from about 1% to about 25%, wherein the cementitious material is geopolymer, ground granulated blast-furnace slag, rice husk ash, adobe, cob, metakaolin, calcium sulfoaluminate, calcium aluminate cement, aluminum oxide, nepheline syenite, kaolin, or bio-cement
optionally the pigment is present at a concentration from about 0.5% to about 20%, wherein the pigment is iron oxide, iron based pigments, linseed based, earth pigments and minerals, titanium dioxide, carbon based pigment, chromium oxides, ultramarine, mica-based pigment, pozzolanic lime wash, plant-based dye, plant-based pigment, clay-based colorant, natural oxide, charcoal, milk paint, natural mineral, natural rock, vegetable oil, seed oil, natural tempera, biological pigment, or geologically derived pigment;
a mineral additive is present at a concentration from about 1% to about 20%, wherein the mineral additive is titanium dioxide, zinc oxide, aluminum oxide, or kaolin, preferably titanium dioxide;
optionally the dispersant is present at a concentration from about 0.1% to about 10%, wherein the dispersant is lignosulfonates, saponins, carboxymethyl starch, guar gum, or xanthan gum;
optionally the biocide is present at a concentration from about 0.1% to about 10%, wherein the biocide is citric acid, boric acid, borax, agricultural waste treated with boric acid or another biocide; and
optionally another pozzolan is present at a concentration from about 1% to about 20%, wherein the another pozzolan is silica fume, wet silica fume, pozzolanic lime, precipitated silica, carbon nanotube, rice husk ash, fly ash, glass-phase pozzolan, amorphous aluminosilicate, vitrified calcium alumino-silicate, blast furnace slag, GGBFS, metakaolin volcanic tuff, calcinated diatomaceous earth, kaolinitic clays, volcanic ash, or glass pozzolan, preferably silica fume,
wherein all percentages are by weight of the building material composition.

48. The building material composition of claim 1, wherein the building material composition is joint compound, sculpture, an ornamental use material, furniture and home goods, 3-dimensional printing material, wall panel, floor tile or wall tile, acoustical panel, pigmented compound or plaster, or cast architectural product.

49. (canceled)

50. The building material composition of claim 41, wherein the building material composition is furniture and home goods.

51.-54. (canceled)

55. The building material composition of claim 46, wherein the building material composition is pigmented compound or plaster.

56. (canceled)

57. A method of sequestering carbon dioxide from an environment, comprising:
mixing a composition of claim 1 with water to form a mixture,
wherein the mixture comprises magnesium oxide, magnesium hydroxide, calcium oxide, and/or calcium hydroxide; and
exposing the mixture to an environment comprising carbon dioxide;
thereby sequestering at least a first portion of the carbon dioxide.

58.-62. (canceled)

63. The method of claim 57, wherein the mixture comprise titanium dioxide as a component and wherein at least part of the titanium dioxide catalyzes a conversion of at least a second portion of the carbon dioxide into a hydrocarbon under ultraviolet light, thereby sequestering at least the second portion of the carbon dioxide.
